(19) United States
(12) Patent Application Publication
(10) Pub. No.: US 2026/0306363 A1
(43) Pub. Date: Oct. 8, 2026

(54) CONNECTING ARRANGEMENT, CONNECTING SYSTEM, CONTAINER AND CONTAINER SYSTEM

(71) Applicant: BOEHRINGER INGELHEIM VETMEDICA GMBH, Ingelheim am Rhein (DE)

(72) Inventors: Marcus Rainer RAHMEL, Ockenheim (DE); Peter BAUER, Hoechheim (DE); Mark BENNETT, Seneca, SC (US); Olaf ECKHARDT, Krefeld (DE); Guido ENDERT, Leichlingen (DE); Johannes KRIEGER, Mellrichstadt (DE); Philipp ZIEGLER, Unsleben (DE)

(73) Assignee: BOEHRINGER INGELHEIM VETMEDICA GMBH, Ingelheim am Rhein (DE)

(21) Appl. No.: 19/457,761

(22) Filed: Jan. 23, 2026

Related U.S. Application Data
(62) Division of application No. 17/792,269, filed on Jan. 21, 2021.

(30) Foreign Application Priority Data
Jan. 24, 2020 (EP) 20153582.0

(51) Int. Cl. A61J 1/20

(52) U.S. Cl. CPC A61J 1/2089; A61J 1/201; A61J 1/2027

(57) ABSTRACT

A fluidic connection for producing a connection between a first container and a second container, wherein, for producing a fluidic connection, a first and second connecting arrangement can be coupled to one another and an opening brought about by the coupling, as a result of which a passage is produced which is suitable for interconnecting the interiors of the containers.

### CROSS REFERENCE TO RELATED APPLICATION

This application is a division of commonly owned, co-pending U.S. Patent Application No. 17/792,269, filed Jul. 12, 2022, which is a § 371 of PCT/EP2021/051324 filed Jan. 21, 2021, which claims priority of European Patent Office (EPO) Application No. 20153582.0, filed Jan. 24, 2020 .

### BACKGROUND OF THE INVENTION

### Field of the Invention

The present invention relates in principle to the production of a fluidic connection or passage. In particular, the present invention relates to connecting arrangements, connecting systems, containers and container systems for producing a fluidic connection or passage between containers as well as to methods for their production.

In the medical sphere it is regularly necessary to transfer substances from one container into another. For example, mixtures of medicaments or substances are produced in a mixing bottle, by transferring first the contents of one container and then of a second container into the mixing bottle, then closing the mixing bottle, and producing a mixture by agitation.

In some cases, which are also a focus of the present invention, substances, in particular liquids, stored in different containers have to be mixed under sterile conditions or while preventing the ingress of foreign substances, also in environments at risk of being contaminated, such as stables. The present invention thus also relates in particular to the production of a fluidic connection or passage which is sealed from the environment and prevents the ingress of foreign substances such as germs.

### Description of the Related Art

In this sector, International Patent Application Publication WO 2013/104550 A1 and corresponding Australian Patent Application Publication AU 2013209081 A1 disclose a kit for the production of a combined vaccine, wherein two bottles each have a septum and the kit comprises a double needle for piercing both septa and thereby providing a continuous fluidic connection between the bottles. However, it has been found that the production of a fluidic connection by means of a double needle or the like leads to a relatively high flow resistance, which may make a transfer between the bottles a slow process.

Furthermore, International Patent Application Publication WO 2016/202465 A2 and corresponding U.S. Patent 11,046,499 B2 disclose a connecting and container system for producing a fluidic connection or passage by means of a bayonet-type movement. In this case, two separate connecting arrangements or containers that are each closed by the connecting arrangement are provided. These are coupled together, producing a continuous fluidic connection. The coupling takes place in two cuts.

In a first step, connecting arrangements are inserted translationally into one another, as a result of which one connecting arrangement is opened by perforation by means of the other connecting arrangement.

Subsequently, by rotating the connecting arrangements relative to one another, an initially closed, non-circular tubular coupling arrangement in the form of a mouth-like portion of the other connecting arrangement is deformed, as a result of which a closure surrounded by the mouth-like portion breaks and thus an opening in this connecting arrangement and as a result the fluidic connection or passage is produced.

The deformation is achieved in that the connecting arrangements have two similar portions that can be inserted into one another and are oval, such that a rotation of the connecting arrangements relative to one another results in the described deformation.

Specifically, this is described on the basis of an oval opening in one connecting arrangement and a neck having an oval cross section in the other connecting arrangement. The neck is deformed during rotation such that its long half-axis is shortened and its short half-axis is lengthened. This deformation creates stresses in a closure (which closed the neck) and consequently breaks and thus produces the fluidic connection or passage. The connecting arrangements may be closed by films or membranes or plates in the delivery state.

The present invention proceeds from International Patent Application Publication WO 2016/202465 A2, and therefore the content thereof is fully included herein. It

has been found that, based on the basic concept described herein, even easier operability or improved reliability is desirable.

### SUMMARY OF THE INVENTION

The problem addressed by the present invention is therefore to specify connecting arrangements, connecting systems, a container blank, containers, container systems and methods by means of which easier operability and/or increased reliability can be achieved.

The present problem is solved by a connecting arrangement according to the present invention as described herein.

In principle, the present invention relates to a connecting system for producing a (continuous and/or irreversible) fluidic connection or passage.

The connecting system has two mutually corresponding connecting arrangements. These can be coupled to one another, as a result of which the (continuous) fluidic connection or passage is produced.

The connecting arrangements are formed separately from one another in an initial state. The connecting arrangements are each suitable for closing a container and for making it possible to open the container by coupling, preferably while also allowing for each single container to be used individually.

One or more of the connecting arrangements preferably (in each case) form a part, in particular a base / bottom, of a container. For this purpose, the connecting arrangement(s) can be inserted into a container blank and can be tightly connected, in particular welded, thereto. Alternatively, the (relevant) connecting arrangement forms an integral component of the container or is formed integrally with other parts of the container. In any case, it is also possible to produce the connecting arrangements separately from the containers and either to connect said arrangements to a container blank to form a container or to use them for the fluidic coupling of containers having different structures.

A container may comprise a removal opening that allows access to an interior of the container for the purpose of removing contents. The removal opening may comprise a closure, in particular a septum. The connecting arrangement is preferably arranged on a side facing away from the closure or the removal opening, i.e., in addition to the removal opening.

At least one of the containers is, and preferably both or all containers are, preferably (each) a bottle. A bottle has a bottle neck comprising the removal opening. In particular, the term "bottle" covers or the bottles is or are wide neck bottles, narrow neck bottles and/or jars having a neck.

The containers are filled or can be filled with liquids, in particular vaccines. Alternatively, or additionally, the containers are filled or can be filled with other substances like powders, lyophilizates, or the like.

Preferably, the container(s) is/are closed in an initial state or delivery state by one of the connecting arrangements.

The connecting arrangements are preferably designed for producing a fluidic connection or passage by means of a bayonet-type movement. Here, the two initially separate connecting arrangements are coupled to one another, producing a continuous fluidic connection. The coupling preferably takes place in two steps and/or the connecting arrangement(s), the connecting system, the containers or the container system having the same are configured to:

In a first step, the connecting arrangements are preferably (exclusively) translationally inserted into one another in the coupling direction or along a coupling axis, as a result of which a first connecting arrangement opens a second connecting arrangement and an opening of the second connecting arrangement is brought about.

The first step preferably opens one of the containers while the interior spaces of the containers are still separated by the closure of the other container.

In the first step, a tubular coupling arrangement, preferably having a non-circular cross section, of the first connecting arrangement preferably acts on a closure of the second connecting arrangement, as a result of which the opening is produced.

The coupling axis preferably corresponds to an axis of symmetry or central axis of the first connecting arrangement and/or the second connecting arrangement. In the first step, a projection of the undeformed tubular coupling arrangement of the first connecting arrangement is preferably located within a mouth of the second connecting arrangement delimiting the opening or its closure.

In a cross-section perpendicular to the coupling axis, an inwardly facing circumferential surface of the non-circular mouth, resembles an outwardly facing circumferential surface of the tubular coupling arrangement having a correspondingly non-circular cross section, such that they can be inserted into one another at least substantially without (radial) deformation. For this purpose, they preferably have a corresponding position, orientation and/or alignment relative to one another before and/or in the first step.

In particular, perforation, breaking and/or cutting takes place. For this purpose, a cutting edge of the first connecting arrangement can act on the closure of the second connecting arrangement. The closure may in particular be formed integrally with the parts of the second connecting arrangement retaining the closure and/or may be formed as a closure plate.

Subsequently, by rotating the connecting arrangements relative to one another about the coupling axis, the initially closed, tubular coupling arrangement of the first connecting arrangement deforms, as a result of which a closure surrounded by the tubular coupling arrangement breaks due to stresses caused by the deformation and thus an opening is (also) produced in this connecting arrangement and as a result the fluidic connection or passage is produced.

The deformation is preferably achieved by the circumferential surface of the non-circular tubular coupling arrangement of the first connecting arrangement and the mouth of the second connecting arrangement being similar to one another and being non-circular, such that a rotation of the connecting arrangements relative to one another results in the described deformation.

Preferably, the tubular coupling arrangement of the first connecting arrangement and the mouth of the second connecting arrangement overlap in a projection along the coupling axis in the state in which they are rotated relative to one another. Accordingly, the mouth of the second connecting arrangement displaces and deforms the tubular coupling arrangement of the first connecting arrangement during the rotation.

When the connecting arrangements that are inserted into one another rotate, i.e. while the tubular coupling arrangement is arranged in the mouth, the mouth acts on the tubular coupling arrangement in a deforming manner.

In particular, the second connecting arrangement comprises an oval mouth into which the tubular coupling arrangement can be inserted due to its corresponding circumferential surface that is oval in cross section. Here, the tubular coupling arrangement is deformed during the rotation such that its long half-axis is shortened and its short half-axis is lengthened.

This deformation creates stresses in a region or closure and consequently breaks and thus produces the fluidic connection or passage.

The closure preferably closes off the tubular coupling arrangement until the tubular coupling arrangement is opened by at least partially removing or destroying the closure.

The closure of the first connecting arrangement or the tubular coupling arrangement and/or the second connecting arrangement may be or may comprise films or membranes and/or plates. The closure(s) are preferably fragile, such that, by the first connecting arrangement acting on the second connecting arrangement, or vice versa, in particular the deformation of the tubular coupling arrangement, breaking and thereby the opening can be brought about.

However, it is also possible for the first connecting arrangement to already be open and for the mouth to therefore already be in the delivery state. In this respect, for some aspects of the present invention, it is sufficient for the first connecting arrangement to be closed.

Furthermore, in particular the first connecting arrangement and the container provided therewith can be implemented independently of the second connecting arrangement with respect to certain aspects of the present invention. Although the combination with the second connecting arrangement to form the connecting system is preferred here as well, advantages may also already be achieved without the second connecting arrangement. This relates in particular to aspects of the present invention described in the following which facilitate deformation of the tubular coupling arrangement and thus the opening therein.

The aspects of the present invention described in the following preferably lie in a use of a container system, wherein a first container comprises a first substance, particularly a first vaccine against a first disease, while a second container comprises a second substance, particularly a second vaccine against a second disease different from the first, for the preparation of a mixture of substances, particularly for the preparation of a combined vaccine for simultaneous immunization against different diseases, wherein the containers are fluidically connected to one another by means of the connecting arrangements, such that the substances are mixed together, particularly to form the combined vaccine. In this way, substances which are incompatible with one another, particularly vaccines, can be quickly and reliably mixed together, immediately before being used and administered jointly, thereby saving time and reducing stress.

The connecting system is preferably suitable and particularly advantageous for producing a fluidic connection between containers, but may alternatively or additionally also be used for some other fluidic connection or attachment, for example of a container to some other apparatus, or may be used quite independently of any containers.

The connecting system is suitable for combining liquids or substances in other forms, such as powders, crystals, or gels. The fluidic connection, thus, is not necessarily to be used for the transfer of liquids.

The proposed connecting system preferably comprises at least or precisely two connecting arrangements. The connecting arrangements are preferably formed to be complementary and/or to correspond to one another. This has the advantage that the fluidic connection can only be produced with connecting arrangements that fit one another. The preferably complementary and/or corresponding configuration of the connecting arrangement also has the advantage that the connecting arrangements fit one another in such a way that the fluidic connection can be produced.

The connecting arrangements are preferably fluidically sealed in each case in an initial state or delivery state. This makes it possible to produce a mixture as required or on the spot, and to use containers which each comprise the respective connecting arrangements, but also to use them separately or independently of one another.

It is preferably provided that the connecting arrangements are configured for mutual opening, the continuous fluidic connection being produced by the mutual opening of the connecting arrangements.

It is in particular provided that the connecting arrangements each serve as means for opening the respective other connecting arrangement, comprise such means or are embodied for this purpose. Such means are preferably secured or fixedly connected to or formed in one piece with the respective connecting arrangement. This advantageously makes it possible to produce the fluidic connection without the use of tools (apart from the connecting arrangements themselves) and particularly enables uncomplicated handling. Advantageously, there is, in particular, no need for any separate tools that have to be moved or operated separately from the connecting arrangements, and for this reason the proposed connecting system has low complexity, is cheap to manufacture, as well as being reliable and robust.

Preferably, the fluidic connection and/or a mechanical connection of the connecting arrangements or containers is permanent and/or non-releasable, once produced. Advantageously this can effectively prevent only partial mixing and/or the ingress of foreign substances during or after the production of the fluidic connection. Thanks to the preferably permanent and/or non-releasable fluidic connection there is no need for the use of septa or the like, even when sterility is required, to produce the fluidic connection. Therefore, a relatively large opening or an opening with a large cross section compared with a needle can be obtained, allowing faster transfer and mixing of the substances.

A connection is non-releasable in the sense of the present invention particularly when the connection can only be disconnected again by damaging or destroying the structure, manually only when applying violent forces and/or only using tools, preferably any of which result in violating the seal integrity or integrity of the construction. A non-releasable connection is particularly a connection produced using snap-fit hooks. However, other solutions are also possible here.

The connecting arrangement or arrangements is or are preferably configured for one-time and/or irreversible opening, particularly by means of the properties of the closure or closures. An opening formed with or by means of or in the connecting system is thus preferably not reclosable.

An opening is non-reclosable or irreversibly opened in the sense of the present invention particularly when it can only be reclosed using special tools and/or by replacing defective parts or adding new parts. A destroyed sealing film or broken closure plate as a preferred form of an opened closure is preferably deemed to be non-reclosable or irreversibly opened in the sense of the present invention even if the destroyed sealing film or broken closure plate could theoretically be replaced and re-instated using corresponding equipment.

The proposed connecting system is hereinafter explained in more detail by reference to two connecting arrangements, the first connecting arrangement and the second connecting arrangement. This does not necessarily imply an opening sequence, but serves primarily to differentiate the connecting arrangements. It is thus particularly possible to produce the second connecting arrangement separately and independently from the first connecting arrangement.

The connecting arrangements are preferably different and/or are configured differently for opening the other respective connecting arrangement. Thus, preferably, different mechanisms are used for opening the different connecting arrangements, or the connecting arrangements are configured for this purpose.

The first connecting arrangement preferably comprises a first opening region, referred to as the first opening region in the following. The first opening region is preferably a closure surrounded by the tubular coupling arrangement.

The second connecting arrangement preferably also comprises an opening region, hereinafter referred to as the second opening region. The second opening region is preferably the closure surrounded by the mouth.

The first opening region of the first connecting arrangement can be opened by deformation of the first connecting arrangement in the region of the tubular coupling arrangement by means of the second connecting arrangement, particularly by a tension cracking, rupturing, bursting and/or detachment of the closure of the first opening region being caused by the deformation.

Preferably, the connecting system is configured such that the second opening region of the second connecting arrangement is initially opened by piercing the second opening region with the first connecting arrangement and the opening region of the first connecting arrangement then being opened by deforming the first connecting arrangement with the second connecting arrangement.

Against this background, the present invention relates to the following aspects, which are implementable individually and separately from one another and may be advantageous, but may also be combined with one another and may exhibit particularly advantageous effects in combinations in a synergistic manner.

Merely for the sake of clarity, keywords are used below as subheadings for different measures.

### Notches

One aspect of the present invention relates to a connecting arrangement for a connecting system for producing a fluidic connection between a first container and a second container, hereinafter referred to as the first connecting arrangement, it being possible, for producing the fluidic connection, for the first connecting arrangement to be coupled to a second connecting arrangement and the connecting system being designed to bring about an opening by coupling the first connecting arrangement to the second connecting arrangement, as a result of which a passage is produced which is suitable for interconnecting the interiors of the containers,

the first connecting arrangement comprising a tubular coupling arrangement having a cutting edge at an open end for opening the second connecting arrangement by means of a translational relative movement of the connecting arrangements relative to one another along a coupling axis,

characterized in that

the coupling arrangement has at least one weakened region which facilitates deformation of the coupling arrangement radially relative to the coupling axis.

As already explained above, the closure of the second connecting arrangement is preferably opened by the cutting edge at the open end of the tubular coupling arrangement of the first connecting arrangement. For this purpose, the tubular coupling arrangement is mechanically stable such that sufficient force can be exerted on the closure of the second connecting arrangement.

In this connection, it has been found that the subsequent deformation of the tubular coupling arrangement is made more difficult by the stability. In an advantageous manner, the at least one weakened region of the coupling arrangement means that deformation of the coupling arrangement is made easier radially relative to the coupling axis. In this way, a torque which is necessary for rotating the connecting arrangements relative to one another for the purpose of deforming the coupling arrangement can advantageously be considerably reduced. As a result, a simpler, more energy-saving and accordingly more convenient formation of the fluidic connection or passage can be achieved as a result.

With other words, a weakened region preferably is a region where a structure is less (mechanically) stable than in the adjacent region(s). The structure having the weakened region, thus preferably, has sections of higher and lower mechanical stability as regards deformability radially relative to the coupling or tube axis.

Concerning the tubular coupling arrangement, the tube wall forming the tubular coupling arrangement or a part thereof preferably has stronger region(s)/sections and/or region(s)/sections of higher stability while the weakened region(s) of the coupling arrangement preferably is/are region(s)/section(s) of the tube wall which have a reduced mechanical stability compared to the other stronger region(s)/section(s) and or region(s)/sections of higher stability. Said stability preferably is at least a mechanical stability counteracting deformation in a direction radially relative to the coupling axis, that is, the weakened regions of the coupling arrangement differs from an unweakened regions of the coupling arrangement. In particular, the weakened region (of the tube wall) of the tubular coupling arrangement differs from the remaining unweakened regions of the (tube wall of the) tubular coupling arrangement as regards mechanical stability/behavior counteracting deformation radially relative to the coupling axis. Even more specifically, the tubular coupling arrangement has a tube wall with at least one weakened region while there is at least one other unweakened region, the weakened region causing a reduced mechanical stability compared to a tubular coupling arrangement not having the weakened region.

The weakened region preferably is realized by one or more notches. However, alternatively or additionally, the weakened region can be formed by a reduced material thickness, by forming the weakened region of a different, preferably less mechanically stable, material than the remaining unweakened region(s), by providing blind holes, stability reducing inclusions or the like.

The cutting edge is provided at the open end of the tubular coupling arrangement. Preferably that is the cutting edge forming an open edge of the tubular coupling arrangement. With other words, the tubular coupling arrangement in particular is or has a tube section with its open edge being configured for cutting, e.g., by forming one or more blades. Regardless of the cutting edge, the tubular coupling arrangement can be closed off. Then, the open end and/or cutting edge preferably extends or projects beyond the closure (in a direction contrary to the coupling direction). That is, the tubular coupling arrangement or the tube (section) forming it can have the closure in its course while the open end (edge) of the tubular coupling arrangement or tube (section) forming the tubular coupling arrangement extends or protrudes from this closure.

It should be noted that it is preferred, but not mandatory that the tubular coupling arrangement is initially closed off and it is preferred but not mandatory that the closure closing off the tubular coupling arrangement can be opened by radial deformation of the tubular coupling arrangement (of the tube walls of the tubular coupling arrangement), although this is particularly preferred.

Moreover, it is particularly preferred that the closure is openable by means of the radial deformation, for example, the closure comprising a weak point or being weak such that the radial deformation of the tubular coupling arrangement effects opening the closure.

However, there might be different mechanisms for opening the closure by means of radial deformation of the tubular coupling arrangement. For example, alternatively or additionally to rupturing the closure or parts thereof, the radial deformation of the tubular coupling arrangement might remove a plug or open a valve, or bring about an opening by an even different mechanism. Anyway, it is preferred that the closure is openable by means of radial deformation of the tubular coupling arrangement which is made easier by means of the weakened region compared to the case where the tubular coupling arrangement does not have such weakened region.

Finally, the weakened region of the tubular coupling arrangement can be provided even if no closure closes off the tubular coupling arrangement. Then, the sufficient stability along or parallel to the coupling axis facilitates opening of the coupling arrangement of the other second connecting arrangement while the simplified radial deformation of the tubular coupling arrangement can be used for different purposes like for material saving or providing some flexibility.

Another aspect of the present invention, which can also be implemented independently, relates to a connecting system for producing a fluidic connection between a first container and a second container, wherein the connecting system comprises the above-described first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

A use of the above-described first connecting arrangement together with the second connecting arrangement is particularly advantageous. In principle, however, it is also possible to use the first connecting arrangement independently of the second connecting arrangement. In particular, this is the case if, in other connections, the cutting edge can be used for opening and, moreover, an opening of the first connecting arrangement is to be brought about by exerting a radial force on the coupling arrangement. In this connection, although the use of the second connecting arrangement together with the first connecting arrangement is particularly advantageous, it is not absolutely necessary.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

The proposed first connecting arrangement in connection with containers which each comprise one of the connecting arrangements and can be coupled to one another by means of the connecting arrangements, such that the fluidic connection or passage between the container interiors can be produced, has proven to be particularly advantageous.

### Italian Balcony

Another aspect of the present invention, which can also be implemented independently, relates to a connecting arrangement for a connecting system for producing a fluidic connection between a first container and a second container, it being possible, for producing the fluidic connection, for the connecting arrangement to be coupled to a second connecting arrangement and the connecting system being designed to bring about an opening by coupling, as a result of which a passage is produced which is suitable for interconnecting the interiors of the containers,

the connecting arrangement comprising a tubular coupling arrangement having a tube axis, the coupling arrangement being closed in an original state and being openable to form the passage by deforming the coupling arrangement transversely to its tube axis,

characterized in that

the coupling arrangement comprises a step portion that extends substantially radially relative to the tube axis and is arranged between a first portion extending at least substantially in parallel with the tube axis and a second portion extending at least substantially in parallel with the tube axis.

With reference to the above explanations, the first connecting arrangement is designed to be opened by the radial deformation of the coupling arrangement. In this connection, the proposed step portion allows for stretching during the radial deformation, thus acting as a bellows. Surprisingly, this considerably reduces the force counteracting radial deformation of the coupling arrangement to an unexpected extent, which advantageously reduces the required force or torque that is necessary for rotating the connecting arrangements for the purpose of opening the first connecting arrangement.

The step portion which extends substantially radially relative to the tube axis preferably has a material thickness like the material thickness of the tube sections the first portion and the second portion.

The first portion of the tubular coupling arrangement preferably is a tube section and/or the second portion of the tubular coupling arrangement is a tube section. The first portion and the second portion more preferably are tube sections of different cross-sectional shapes and/or diameters. The step portion in this context preferably connects the ends of the first and the second portion, i.e., the tubular sections at their ends bordering said step portion. The step portion can essentially be in the shape of a ring, preferably having differently shaped inner and outer circumferential lines and/or a varying ring thickness/radial extension of the material forming the ring. In particular, the step portion is formed by a ring having an at least circular outer circumferential line while the inner circumferential line is non-circular, in particular oval.

The first portion and the second portion connected by the step portion preferably form a bellow. In this context, a bellow preferably is a structure allowing or simplifying radial deformation of by folding the first portion, the step portion, and the second portion relative to one another, preferably thus stretching or compressing the tubular coupling arrangement. This preferably means that the radial deformation due to the bellow function extends or reduces a distance of the end of the first portion of the coupling arrangement which is remote of the end of the step portion from the end of the second portion of the coupling arrangement which is remote of the step portion.

Another aspect of the present invention, which can also be implemented independently, relates to a connecting system for producing a fluidic connection between a first container and a second container, wherein the connecting system comprises the above-described first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

As already explained above, the use of the improved first connecting arrangement together with a second connecting arrangement in the form of a connecting system is particularly advantageous, even if the first connecting arrangement can advantageously in principle also be used separately from the second connecting arrangement.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

As already explained above, the use of the proposed first connecting arrangement and of the connecting system together therewith in a container system is particularly well suited to producing the fluidic connection or passage.

### Bumps

Another aspect of the present invention, which can also be implemented independently, relates to a connecting system for producing a fluidic connection, preferably between a first container and a second container, wherein the connecting system for producing a fluidic connection comprises a first connecting arrangement and a second connecting arrangement, which can be coupled to one another and are designed to bring about an opening by coupling, as a result of which a passage is produced which is suitable for interconnecting the interiors of the containers,

one of the first and second connecting arrangements comprising a tubular sealing arrangement and another of the first and second connecting arrangements having a structure that is complementary to the tubular sealing arrangement, in particular a receptacle, such that the tubular sealing arrangement comes into sealing contact with the complementary structure by means of a translational relative movement of the connecting arrangements along a coupling axis,

the sealing arrangement comprising an in particular outwardly facing circumferential sealing surface for sealing contact with an in particular inwardly facing circumferential sealing surface of the complementary structure,

the connecting system being characterized in that

the other of the first and second connecting arrangements comprises one or more pressing elements that are preferably radially offset inwards with respect to the coupling axis relative to the circumferential sealing surface of the complementary structure in order to press the circumferential sealing surface of the tubular sealing arrangement against the circumferential sealing surface of the complementary structure.

Preferably, the proposed connecting system allows for the connection or formation, which is sealed from the environment, of a passage that is closed to the environment between containers or the like. In particular, in connection with the deformation of the tubular coupling arrangement carried out for the purpose of opening the first connecting arrangement, it has been found that the sealing effect of the sealing arrangement can be improved by means of the proposed pressing elements or can even be ensured if said deformation of the tubular coupling arrangement also acts on the sealing arrangement due to any transfer of material tension.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

In this connection, the improved sealing effect is particularly advantageous, in particular if containers are to be coupled to one another in connection with medical products or containing medical products, for example to produce a combination vaccine or to bring about rehydration of lyophilizate.

### Seal Bead

Another aspect of the present invention, which can also be implemented independently, relates to a connecting system for producing a fluidic connection, preferably between a first container and a second container, wherein the connecting system for producing a fluidic connection comprises a first connecting arrangement and a second connecting arrangement, which can be coupled to one another and are designed to bring about an opening by coupling, as a result of which a passage is produced which is suitable for interconnecting the interiors of the containers,

the first connecting arrangement comprising a tubular sealing arrangement and the second connecting arrangement comprising a structure that is complementary to the tubular sealing arrangement, in particular a preferably tubular or hollow-cylindrical receptacle, the sealing arrangement comprising an in particular outwardly facing circumferential sealing surface for sealing contact with the in particular inwardly facing circumferential sealing surface of the receptacle,

characterized in that

the first connecting arrangement comprises a bead along the circumferential surface of the tubular sealing arrangement, which bead has an oversize relative to the circumferential surface of the complementary structure.

In the present aspect of the present invention, the sealing of the fluidic connection or passage to the environment that is formed by coupling the connecting arrangements is improved. Although it has been found that the tubular sealing arrangement basically produces a certain sealing effect similar to that of a sealing lip, this effect can be improved by providing the proposed bead.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container and the second container can be coupled to one another by means of the first connecting arrangement and the second connecting arrangement and are designed to bring about an opening by coupling, as a result of which a passage is produced between the interiors of the containers which interconnects the interiors of the containers.

### Non-Interchangeability

Another aspect of the present invention, which can also be implemented independently, relates to a connecting system for producing a fluidic connection, preferably between a plurality of containers,

the connecting system for producing a fluidic connection comprising a first connecting arrangement and a second connecting arrangement, which can be coupled to one another and are designed to bring about an opening by coupling, as a result of which a passage is produced, and

the connecting system for producing a fluidic connection comprising a third connecting arrangement and a fourth connecting arrangement, which can be coupled to one another and are designed to bring about an opening by coupling, as a result of which a passage is produced, the first connecting arrangement and the third connecting arrangement being constructed substantially identically and the second connecting arrangement and the fourth connecting arrangement being constructed substantially identically, such that, in principle, it is possible to couple the first connecting arrangement to the fourth connecting arrangement and/or to couple the second connecting arrangement to the third connecting arrangement,

the connecting system being characterized in that

the connecting arrangements additionally comprise a mechanism formed by a bayonet catch, which makes it possible to couple the first connecting arrangement to the second connecting arrangement and to couple the third connecting arrangement to the fourth connecting arrangement, while it prevents the first connecting arrangement from being coupled to the fourth connecting arrangement and/or prevents the second connecting arrangement from being coupled to the third connecting arrangement.

The third connecting arrangement preferably corresponds to the first connecting arrangement with regard to further aspects. The fourth connecting arrangement preferably corresponds to the second connecting arrangement with regard to further aspects.

It has been found to be particularly effective and resource-saving to provide such a mechanism, in particular if different package sizes include the same or similar coupling arrangements and/or mouths. Surprisingly, it has been found in this connection to be particularly effective to bring about compatibilities or incompatibilities between different connecting arrangements of different or identical container sizes by different types of bayonet catch being used.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

In a synergistic manner, the bayonet catches can be used both for the coupling and/or non-detachable connection of the associated containers, as well as to ensure that containers can be coupled only if the container sizes correspond to one another and the result of mixing the contents of both containers is also suitable for the relevant application.

### Flat cookie

Another aspect of the present invention, which can also be implemented independently, relates to a connecting arrangement for a connecting system for producing a fluidic connection between a first container and a second container, it being possible, for producing the fluidic connection, for the connecting arrangement to be coupled to a second connecting arrangement and the connecting system being designed to bring about an opening by coupling, as a result of which a passage is produced which is suitable for interconnecting the interiors of the containers,

the connecting arrangement comprising a tubular coupling arrangement having a tube axis, the coupling arrangement being closed in an original state and being openable to form the passage by deforming the coupling arrangement transversely to its tube axis,

the coupling arrangement comprising a closure plate that is integrally formed with the coupling arrangement and is connected to the coupling arrangement by a line of weakness, the line of weakness being suitable for rupturing by deformation of the coupling arrangement in order to form the passage,

the connecting arrangement being characterized in that

the closure plate extends perpendicularly to the tube axis and comprises asymmetrically arranged reinforcing structures.

Closure plates that extend perpendicularly to the tube axis are known in principle. In connection with the opening in this tubular coupling arrangement that surrounds said opening by deformation, an inclination of the closure plate relative to the coupling axis has, however, been found to be advantageous in the prior art in principle. In particular with small package sizes, it has, however, surprisingly been found that a sufficient opening width can be better ensured if the closure plate is not inclined in such cases, but instead extends perpendicularly to the tube axis or coupling axis, and if the closure plate also comprises asymmetrically arranged reinforcing structures, in particular stiffening structures such as ribs.

Another aspect of the present invention, which can also be implemented independently, relates to a connecting system for producing a fluidic connection between a first container and a second container, wherein the connecting system comprises the above-described connecting arrangement as a first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Toothed Bottom Container

Another aspect of the present invention, which can also be implemented independently, relates to a container formed from a container blank and a connecting arrangement for a connecting system, the connecting system being designed for producing a fluidic connection between the container and a second container, it being possible, for producing the fluidic connection, for the connecting arrangement to be coupled to a complementary connecting arrangement of the second container and the connecting system being designed to bring about an opening by coupling the connecting arrangement to the other connecting arrangement, as a result of which a passage is produced which is suitable for interconnecting the interiors of the containers,

it being possible for the container blank and the connecting arrangement to be inserted into one another,

the container being characterized in that

the container blank and the connecting arrangement have form-fitting elements that are formed to be complementary to one another and prevent the connecting arrangement and the container blank from rotating relative to one another by means of a form fit when said connecting arrangement is inserted into said container blank.

As explained at the outset, the first connecting arrangement is opened by a deformation of the coupling arrangement taking place while the connecting arrangements rotate relative to one another. The deformation brings about a counterforce. When one or more containers are formed by inserting a connecting arrangement into a container blank, it has proven to be advantageous for the stability of the container, in particular with regard to the torque to be transmitted from the container blank to the connecting arrangement during rotation of the containers and therefore of the connecting arrangements relative to one another, not only to provide a bonded connection but also to in particular provide interlocking teeth and, if necessary, to additionally provide a bonded connection such as an adhesive bond, a welded joint or the like. This allows for particularly high reliability of the resulting container.

Another aspect of the present invention, which can also be implemented independently, relates to a container system comprising the above-described first container and a second container, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

Owing to the improved reliability of the individual container or containers by the measure in this aspect of the present invention, the resulting container system comprising the container or containers is also more reliable.

Another aspect of the present invention, which can also be implemented independently, relates to a method for producing a container comprising a container blank and a connecting arrangement for a connecting system for producing a fluidic connection between the container and a second container, it being possible, for producing the fluidic connection, for the connecting arrangement to be coupled to a complementary connecting arrangement of the second container and the connecting system being designed to bring about an opening by coupling the first connecting arrangement to the second connecting arrangement, as a result of which a passage is produced which is suitable for interconnecting the interiors of the containers, wherein the container blank and the connecting arrangement have form-fitting elements that are formed to be complementary to one another and prevent the connecting arrangement and the container blank from rotating relative to one another by means of a form fit when said connecting arrangement is inserted into said container blank, and wherein the container blank and the first connecting arrangement are inserted into one another by means of an insertion movement, wherein, by means of the form-fitting elements, a position of the container blank relative to the connecting arrangement is predetermined and/or a form fit is formed which prevents the container blank and the connecting arrangement from rotating relative to one another.

As a result, corresponding advantages are achieved.

### Container Ribs Bottom Hold

Another aspect of the present invention, which can also be implemented independently, relates to a container formed from a container blank and a connecting arrangement for a connecting system for producing a fluidic connection between the container and a second container, hereinafter referred to as the first connecting arrangement, it being possible, for producing the fluidic connection, for the first connecting arrangement to be coupled to a second connecting arrangement of the second container and the connecting system being designed to bring about an opening by coupling the first connecting arrangement to the second connecting arrangement, as a result of which a passage is produced which is suitable for interconnecting the interiors of the containers,

it being possible for the container blank and the first connecting arrangement to be inserted into one another by means of an insertion movement and the container blank preferably comprising rib-like stiffening structures,

the container being characterized in that

the stiffening structures comprise open ends and the first connecting arrangement comprises coupling structures that are formed to be complementary thereto, engage in one another when the connecting arrangement is inserted into the container blank, and prevent any rotation relative to one another by means of a form fit.

This enables improved reliability in a synergistic manner. This is because, on one hand, the stiffening structures allow for improved wall stability of the container and, on the other hand, said stiffening structures are used in addition to achieve a rotationally fixed coupling of the container blank to the connecting arrangement by means of a form fit. As a result, the resulting container becomes both more robust against deformation due to the application of force from outside and becomes more reliable in terms of transmitting torque from the container blank to the connecting arrangement inserted therein.

Another aspect of the present invention, which can also be implemented independently, relates to a container system comprising an above-described container as the first container and a second container, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

Accordingly, the container system is also more robust and reliable if the measures according to the present aspect are implemented in one or both containers of the container system.

Another aspect of the present invention, which can also be implemented independently, relates to a method for producing a container made up of a container blank and a connecting arrangement for a connecting system for producing a fluidic connection between the container and a second container, it being possible, for producing the fluidic connection, for the connecting arrangement to be coupled to a complementary connecting arrangement of the second container and the connecting system being designed to bring about an opening by coupling the first connecting arrangement to the second connecting arrangement, as a result of which a passage is produced which is suitable for interconnecting the interiors of the containers,

it being possible for the container blank and the first connecting arrangement to be inserted into one another by means of an insertion movement and the container blank preferably comprising rib-like stiffening structures,

wherein the stiffening structures comprise open ends and the connecting arrangement comprises coupling structures that are formed to be complementary thereto, and

wherein the container blank and the connecting arrangement are inserted into one another by means of an insertion movement, as a result of which the open ends and the coupling structures engage in one another, such that the container blank and the connecting arrangement are prevented from rotating relative to one another and/or a (preferably specific rotational and/or axial) position of the container blank relative to the connecting arrangement is predetermined during the insertion.

The production of the container based on a container blank and a connecting arrangement is first advantageous in that the (respectively) connecting arrangement can be produced by an injection moulding process, while the (respectively) container blank can be produced by injection molding separately, or – in some cases more easily and cost-effectively – by means of blow moulding. A sufficient ability to transmit torques from the container blank to the relevant connecting arrangement such that the first connecting arrangement can be opened by the deformation is accordingly improved by the measures provided.

### Hybrid Bottom Ribs

Another aspect of the present invention, which can also be implemented independently, relates to a connecting arrangement for a connecting system for producing a fluidic connection between a first container and a second container, it being possible, for producing the fluidic connection, for the connecting arrangement to be coupled to a second connecting arrangement and the connecting system being designed to bring about an opening by coupling, as a result of which a passage is produced which is suitable for interconnecting the interiors of the containers,

the connecting arrangement comprising a tubular coupling arrangement having a tube axis, the coupling arrangement being closed in an original state and being openable to form the passage by deforming the coupling arrangement transversely to its tube axis, or the connecting arrangement comprising a mouth closed by a closure,

characterized in that

the coupling arrangement or mouth is connected to a circumferential outer wall by an offset, which preferably extends at least substantially radially or perpendicularly relative to the coupling axis and/or is flange-like or collar-like, the offset being stiffened by one or more ribs.

It has proven to be advantageous in principle to use the same coupling arrangement or mouth for different package sizes. The background here is that, on one hand, scaling of the structures beyond a certain container size is no longer necessary and, on the other hand, results in torques which are difficult to handle in order to bring about the opening in the first connecting arrangement. To counteract this, a coupling arrangement or mouth that is suitable for a smaller package size can also be used for larger package sizes. In practice, however, obstacles have arisen in that the stability of the construction suffers and reliable opening of the first and/or second connecting arrangement cannot always be ensured. The present invention offers a remedy in this regard by an offset for adapting a coupling arrangement or mouth of a smaller package size being provided for use with a larger package size, which offset is stiffened. In this case, the proposed ribs have surprisingly proven to be particularly effective.

Another aspect of the present invention, which can also be implemented independently, relates to a connecting system for producing a fluidic connection between a first container and a second container, wherein the connecting system comprises an above-described connecting arrangement as a first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Container Ribs

Another aspect of the present invention, which can also be implemented independently, relates to a container blank for a first and/or second container for forming a container system comprising a connecting system for producing a fluidic connection between the first container and second container, it being possible, for producing the fluidic connection, for a first connecting arrangement to be coupled to a second connecting arrangement and the connecting system being designed to bring about an opening by the coupling, as a result of which a passage is produced which is suitable for interconnecting the interiors of the containers,

the container blank comprising a bottle neck that opens into a removal opening and a circumferential outer wall which connects the bottle neck to an open tubular end provided on the side facing away from the bottle neck, for inserting the connecting arrangement,

the container blank being characterized in that

the container blank comprises one or more ribs for stiffening the outer wall which extend at least substantially from the bottle neck in the direction of the open end.

The proposed ribs along the container blank have proven to be particularly effective for preventing deformation and in particular indentations in the container formed by the container blank and the connecting arrangement. The proposed ribs in the proposed arrangement make a double effect possible in a synergistic manner. On one hand, namely a radial deformation of the container formed by the container blank is prevented and on the other hand, the ribs increase axial stiffness of the container or container blank, which means that, even with relatively thin container walls, sufficient force can be exerted in the direction of the coupling axis from the container blank onto the connecting arrangement, in order to bring about an opening in the second connecting arrangement by means of the cutting edge of the first connecting arrangement.

Another aspect of the present invention, which can also be implemented independently, relates to a container formed from an above-described container blank and a connecting arrangement for a connecting system for producing a fluidic connection between the container and a second container, it being possible, for producing the fluidic connection, for the connecting arrangement to be coupled to a complementary connecting arrangement of the second container and the connecting system being designed to bring about an opening by coupling the connecting arrangement to the complementary connecting arrangement, as a result of which a passage is produced which is suitable for interconnecting the interiors of the containers, the first connecting arrangement being in contact with the stop formed by the ribs.

Another aspect of the present invention, which can also be implemented independently, relates to a container system comprising an above-described container as the first container and a second container, wherein the first container comprises the connecting arrangement and the second container comprises the complementary connecting arrangement, and wherein the first container can be coupled to the second container by means of the connecting arrangement and the complementary connecting arrangement and are designed to bring about an opening by coupling, as a result of which a passage is produced between the interiors of the containers which interconnects the interiors of the containers.

### Beak Support

Another aspect of the present invention, which can also be implemented independently, relates to a connecting arrangement for a connecting system for producing a fluidic connection between a first container and a second container, hereinafter referred to as the first connecting arrangement, it being possible, for producing the fluidic connection, for the first connecting arrangement to be coupled to a second connecting arrangement and the connecting system being designed to bring about an opening by coupling the first connecting arrangement to the second connecting arrangement, as a result of which a passage is produced which is suitable for interconnecting the interiors of the containers,

the connecting arrangement comprising a tubular coupling arrangement having a tube axis, the coupling arrangement being closed in an original state and being openable to form the passage by deforming the coupling arrangement transversely to its tube axis,

the first connecting arrangement comprising a cutting edge at an open end of the tubular coupling arrangement for opening the second connecting arrangement by means of a translational relative movement of the connecting arrangements relative to one another along the tube axis,

the tubular coupling arrangement comprising a circumferential wall,

the first connecting arrangement being characterized in that

the circumferential wall of the tubular coupling arrangement comprises one or more ribs and/or folded structures for stiffening the tubular coupling arrangement in the direction of the tube axis.

Advantageously, the proposed coupling arrangement allows improved stability in the direction of the coupling axis, with possible buckling of the material forming the wall of the coupling arrangement being prevented, as a result of which the reliability can be improved.

Another aspect of the present invention, which can also be implemented independently, relates to a connecting system for producing a fluidic connection between a first container and a second container, wherein the connecting system comprises an above-described connecting arrangement as a first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Oval Contact

Another aspect of the present invention, which can also be implemented independently, relates to a connecting arrangement for a connecting system for producing a fluidic connection between a first container and a second container, hereinafter referred to as the first connecting arrangement, it being possible, for producing the fluidic connection, for the first connecting arrangement to be coupled to a second connecting arrangement and the connecting system being designed to bring about an opening by coupling the first connecting arrangement to the second connecting arrangement, as a result of which a passage is produced which is suitable for interconnecting the interiors of the containers,

the connecting arrangement comprising a tubular coupling arrangement having a tube axis, the coupling arrangement being closed in an original state and being openable to form the passage by deforming the coupling arrangement transversely to its tube axis,

the first connecting arrangement comprising a cutting edge at an open end of the tubular coupling arrangement for opening the second connecting arrangement by means of a translational relative movement of the connecting arrangements relative to one another along the tube axis,

the tubular coupling arrangement comprising a circumferential wall,

characterized in that

the circumferential wall of the tubular coupling arrangement has a radius or external diameter that increases starting from the cutting edge.

For sufficient deformation of the coupling arrangement of the first connecting arrangement, it is advantageous to first minimize play / clearance between the radially outwardly facing circumferential surface of the coupling arrangement and the at least substantially complementarily shaped mouth of the second connecting arrangement. This is because the smaller the play / clearance is, the more directly rotation acts as intended on the coupling arrangement in a deforming manner. In order to reduce the play / clearance between the coupling arrangement and the mouth for this purpose, but at the same time to allow the insertion of the connecting arrangements into one another, the proposed increasing radius or external diameter has proven to be advantageous.

Another aspect of the present invention, which can also be implemented independently, relates to a connecting system for producing a fluidic connection between a first container and a second container, wherein the connecting system comprises an above-described connecting arrangement as a first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Cookie-Stopper

Another aspect of the present invention, which can also be implemented independently, relates to a connecting arrangement for a connecting system for producing a fluidic connection between a first container and a second container, hereinafter referred to as the first connecting arrangement, it being possible, for producing the fluidic connection, for the first connecting arrangement to be coupled to a second connecting arrangement and the connecting system being designed to bring about an opening by the coupling, as a result of which a passage is produced which is suitable for interconnecting the interiors of the containers, the connecting arrangement comprising a tubular coupling arrangement having a tube axis, the coupling arrangement being closed in an original state and being openable to form the passage by deforming the coupling arrangement transversely to its tube axis,

the coupling arrangement comprising a closure plate which closes the coupling arrangement and brings about the opening to form the passage by means of the deformation,

the connecting arrangement being characterized in that

the closure plate comprises a structure that extends transversely to a main plane of extension and is designed to form a stop on a side of the closure plate facing the structure after opening, by means of which stop the closure plate is supported on the coupling arrangement, preferably after the initiation of opening but before complete opening, or during the progress of opening, in order to also cause an opening on a side facing away from the stop.

The proposed solution makes it possible to ensure that the closure, in particular the closure plate, of the first connecting arrangement reaches a sufficient opening width.

Another aspect of the present invention, which can also be implemented independently, relates to a connecting system for producing a fluidic connection between a first container and a second container, wherein the connecting system comprises an above-described connecting arrangement as a first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Cookie Light

Another aspect of the present invention, which can also be implemented independently, relates to a connecting arrangement for a connecting system for producing a fluidic connection between a first container and a second container, hereinafter referred to as the second connecting arrangement, it being possible, for producing the fluidic connection, for a first connecting arrangement to be coupled to the second connecting arrangement and the connecting system being designed to bring about an opening by coupling the first connecting arrangement to the second connecting arrangement, as a result of which a passage is produced which is suitable for interconnecting the interiors of the containers,

the second connecting arrangement comprising a closure which can be opened by means of a translational relative movement of the connecting arrangements along a coupling axis relative to one another by means of a cutting arrangement of the first connecting arrangement,

the second connecting arrangement being characterized in that

the closure is formed by a closure plate which is delimited by a fragile line of weakness and additionally comprises a weakened region.

In principle, it is advantageous to use an at least substantially rigid closure plate, since a larger opening width can be achieved thereby. However, it has been found, in particular in connection with the second connecting arrangement, that the stiffness of such a closure plate may make it difficult to make the opening in the second connecting arrangement by means of the cutting edge of the first connecting arrangement. In this connection of the present aspect, a remedy is provided by a weakening in the closure plate allowing a certain degree of deformation and thus facilitating successive opening. Successive opening in particular means an opening process, in which the closure plate does not break out suddenly, but to some degree continuously over time and/or following a movement of the cutting edge.

Another aspect of the present invention, which can also be implemented independently, relates to a connecting system for producing a fluidic connection between a first container and a second container, wherein the connecting system comprises a connecting arrangement and an above-described second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Base Cap Remover

Another aspect of the present invention, which can also be implemented independently, relates to a connecting arrangement for a connecting system for producing a fluidic connection between a first container and a second container, the connecting system comprising the connecting arrangement and a complementary connecting arrangement, it being possible, for producing the fluidic connection, for the first connecting arrangement to be coupled to a second connecting arrangement and the connecting system being designed to bring about an opening by coupling the first connecting arrangement to the second connecting arrangement, as a result of which a passage is produced which is suitable for interconnecting the interiors of the containers,

the connecting arrangement comprising a closure cap, the connecting arrangement and the closure cap comprising mutually corresponding guide surfaces,

the connecting arrangement being characterized in that

the guide surfaces have an incline relative to one another such that, when the closure cap rotates relative to the connecting arrangement, a force that separates the closure cap from the connecting arrangement is generated.

It is preferable for the connecting arrangement(s) to be protected against contamination by germs or the like by means of the closure cap(s) in the delivery state. For this purpose, it is more preferable for the closure cap to cover or close the relevant connecting arrangement tightly, in particular in a watertight, airtight and particularly preferably bacteria-tight manner. Accordingly, it may be the case that removing the relevant closure cap requires a certain force in order to overcome the frictional connection formed by the tight-fitting closure cap. In particular in this connection, the present aspect has proven advantageous for making it possible to easily and conveniently remove the closure cap.

Another aspect of the present invention, which can also be implemented independently, relates to a connecting system for producing a fluidic connection between a first container and a second container, wherein the connecting system comprises an above-described first and second connecting arrangement and another connecting arrangement of the first and second connecting arrangements corresponding thereto, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Double Beaks

Another aspect of the present invention, which can also be implemented independently, relates to a connecting arrangement for a connecting system for producing a fluidic connection between a first container and a second container, hereinafter referred to as the first connecting arrangement, it being possible, for producing the fluidic connection, for the first connecting arrangement to be coupled to a second connecting arrangement and the connecting system being designed to bring about an opening by coupling, as a result of which a passage is produced which is suitable for interconnecting the interiors of the containers,

the first connecting arrangement comprising a tubular coupling arrangement, the tubular coupling arrangement comprising a cutting edge at an open edge of the tubular coupling arrangement, the cutting edge being designed to open a closure of the second connecting arrangement,

the connecting arrangement being characterized in that

the cutting edge has at least or exactly two protruding, preferably beak-shaped, piercing sections which are configured, when coupling the connecting arrangements by translational relative movement, that both piercing sections essentially simultaneously act on the second connecting arrangement such that the closure is opened by breaking it at two distinct positions essentially simultaneously.

The piercing sections preferably have a similar shape. The shape preferably is sharp, spiky, tapered and/or pointed. The piercing sections preferably form piercing elements.

The piercing sections are preferably arranged remote from each other. Preferably, the piercing sections are arranged on opposite sides of the cutting edge. In particular, the piercing sections are arranged at the open edge of the tubular coupling arrangement at positions where the tubular coupling arrangement has its maximum cross section.

The piercing sections of the cutting edge are preferably configured to open the second connecting arrangement particularly as a result of the closure of the second connecting arrangement being perforated or pierced by means of both or all piercing sections of the cutting edge.

Preferably, during an axial movement of the connecting arrangements to one another, the closure of the second connecting arrangement is first of all pierced by the piercing sections projecting axially outwards relative to the closure or remainder of the cutting edge.

Preferably, only afterwards can the closure of the first connecting arrangement be opened by the rotation of the connecting arrangements relative to one another in the manner described.

The cutting edge and/or piercing sections preferably correspond in its / their orientation and position to the frangible point of the second connecting arrangement, such that bringing the connecting arrangements together leads to the piercing sections of cutting edge being applied to the frangible point, as a result of which the frangible point can be severed, starting at the initial points of application of the cutting edge, namely, the piercing sections. Preferably, the connecting arrangements are correspondingly guided to one another.

Another aspect of the present invention, which can also be implemented independently, relates to a connecting system for producing a fluidic connection between a first container and a second container, wherein the connecting system comprises an above-described connecting arrangement as a first connecting arrangement and a second connecting arrangement, wherein the first connecting arrangement and the second connecting arrangement can be coupled to one another and are designed to bring about an opening by coupling, as a result of which a passage is produced which is suitable for interconnecting the interiors of the containers.

Another aspect of the present invention, which can also be implemented independently, relates to a container system comprising a first container and a second container, wherein the container system comprises the above-described connecting system, wherein the first container comprises the first connecting arrangement and the second container comprises the second connecting arrangement, and wherein the first container can be coupled to the second container by means of the first connecting arrangement and the second connecting arrangement and are designed to bring about an opening by coupling, as a result of which a passage is produced between the interiors of the containers which interconnects the interiors of the containers.

### Torque Block

Another aspect of the present invention, which can also be implemented independently, relates to a connecting arrangement for a connecting system for producing a fluidic connection between a first container and a second container, the connecting system comprising a first connecting arrangement and a second connecting arrangement, it being possible, for producing the fluidic connection, for the first connecting arrangement to be coupled to the second connecting arrangement and the connecting system being designed to bring about an opening by coupling the first connecting arrangement to the second connecting arrangement, as a result of which a passage is produced which is suitable for interconnecting the interiors of the containers.

The connecting arrangement is the first connecting arrangement or the second connecting arrangement and comprises a closure cap, which preferably is a base cap mounted on and/or covering the base of a container or bottle which comprises the connecting arrangement at its bottom and/or on an opposite site of its withdrawal opening. The closure cap preferably is removably mounted or mountable on the connecting arrangement. In particular, the closure cap closes off the opening region of the connecting arrangement until it is removed.

According to this aspect, the connecting arrangement and the closure cap are mounted rotatable relative to each other, and comprise a separating tool moving away the closure cap from the connecting arrangement caused by the rotation when the connecting arrangement and the closure cap are rotated relative to each other, and comprise corresponding blocking elements for releasably blocking the rotation until a torque threshold is exceeded and/or torque peak is overcome.

The closure cap preferably is held on the connecting arrangement by snap-locking. Accordingly, for removing the closure cap a sufficiently high force needs to be applied to the closure cap or the connecting arrangement such that the snap-lock is overcome. As already discussed in context of the aspect “base cap remover”, there can be provided a mechanism for facilitating removal of the closure cap by turning it relatively to the connecting arrangement. In context of such mechanism either as discussed previously or realized differently, it turned out that it is appreciated to improve the packaging reliability. In particular, it is an object to avoid unintended removal of the closure cap from the connecting arrangement.

It has been surprisingly found that providing the blocking elements that releasably block the rotational movement of the closure cap relative to the connecting arrangement enables providing a torque threshold (minimum torque value for starting rotational movement of the closure cap and the connection arrangement) and/or a torque peak (a local torque maximum) which is to be overcome in order to enable starting the rotational movement of the closure cap relative to the connecting arrangement. This in synergistic combination with the separating tool which is configured for moving away the closure cap from the connecting arrangement advantageously results in a more reliable packaging as unintended rotational movement of the closure cap relative to the connecting arrangement is blocked, and, thus, unintended removal of the closure cap from the connecting arrangement can be avoided. The separating tool preferably is a structure / geometry for lifting and/or levering off the closure cap from the connecting arrangement.

The connecting arrangement and the closure cap preferably comprise corresponding guide surfaces, wherein the blocking elements are assigned to or arranged at the guide surfaces. The guide surfaces in particular are or are provided by a cam and a corresponding slide, the cam being configured to slide along and being guided by the slide. The guide surfaces preferably are those discussed previously in context of the aspect “base cap remover”, but alternatively or additionally can be realized similarly or differently. In particular, a combination of a cam and a slide is particularly preferred as it turned out as an advantageous combination for realizing the separating force which is applied to the closure cap in order to remove it from the connecting arrangement, in particular for overcoming a snap lock by means of which the closure cap can be held at the connecting arrangement.

Of course, the connecting arrangement can form part, in particular a bottom, of a container and, in particular, of a bottle having a withdrawal opening on an opposite side of the connecting arrangement. However, as the connecting arrangement can be applied to different purposes alternatively or additionally, in the following discussion the focus keeps on the combination of the connecting arrangement and the closure cap.

The guide surfaces preferably have an incline relative to one another such that, when the closure cap rotates relative to the connecting arrangement, a force that separates the closure cap from the connecting arrangement is generated.

The separating tool preferably demand the connecting arrangement and the closure cap to be rotated relative to each other to some extent before the separating force starts to be effected, driven by continued rotation. The blocking effected by the blocking elements, thus, needs to be overcome before the separating force can be effected with the separating tool In particular, the locking elements are arranged at corresponding positions of the closure cap and the connecting arrangement such that they removably engage when the closure cap is held on and covers the connecting arrangement, preferably at least in one specific rotational position of the closure cap and the connecting arrangement relative to one another.

For example, the separating tool for moving away the closure cap from the connecting arrangement can be realized essentially as previously discussed, namely, based on at least one inclined guide surface which causes pressing away the closure cap from the connecting arrangement upon rotational movement of the closure cap relative to the connecting arrangement. However, different mechanisms for separation effected by relative rotational movement of the closure cap and the connecting arrangement can advantageously be combined with the blocking elements as well.

The blocking elements preferably are releasably snap fitted to each other, the snap fit connection being releasable upon applying a torque between the connecting arrangement and the closure cap exceeding the threshold and/or overcoming the peak.

The blocking elements can be engaged radially and/or axially relative to an axis about which the closure cap and the connecting arrangement are rotatable relative to each other.

The engagement is or can be released upon start of the rotation causing the torque peak (threshold), i.e., when the torque peak occurs. In particular, the engagement of the blocking elements in a specific rotational position of the closure cap and the connecting arrangement can block the rotational movement up to a specific torque value (threshold). Once this specific torque value is reached, the engagement can be overcome, i.e., the blocking elements can be separated from one another, and afterwards a reduced torque is sufficient for the rotational movement (the rotational movement causes less torque, e.g. due to the remaining friction).

When the torque threshold is exceeded and/or the torque peak is overcome, continued rotation of the connecting arrangement and the closure cap relative to each other preferably demands for less torque than the threshold even when continuing the rotation after a stop-off. That is, the torque threshold preferably is higher than the threshold needed for overcoming static friction of the closure cap and the connecting arrangement without the blocking elements being involved.

For further aspects reference is made to previously and in the following discussed aspects, and in particular to the aspect under section “base cap remover”.

Still a further aspect of the present invention, which can be realized independently as well, relates to a connecting system for producing a fluidic connection between a first container and a second container, wherein the connecting system comprises the first connecting arrangement and second connecting arrangement, wherein the first connecting arrangement and the second connecting arrangement can be coupled to one another after removing the closure cap and are designed to bring about an opening by coupling, as a result of which a passage is produced which is suitable for interconnecting the interiors of the containers, wherein in an initial configuration one of the connecting arrangements is closed off by a closure cap, the connecting arrangement and the closure cap are mounted rotatable relative to each other.

The connecting arrangement and the closure cap comprise a separating tool moving away the closure cap from the connecting arrangement caused by the rotation when the connecting arrangement and the closure cap are rotated relative to each other, and the connecting arrangement and the closure cap comprise corresponding blocking elements for releasably blocking the rotation until a torque threshold is exceeded and/or torque peak is overcome. Afterwards, the connecting arrangement and the closure cap can be separated by continued rotation enabling the connecting arrangements to be coupled.

### Definitions

A "container" in the sense of the present invention is preferably a device being capable for transporting and storing fluids, particularly liquids, gases and pourable solids such as powders.

A "container blank" in the sense of the present invention is preferably a semi-finished product which forms part of a container to be produced. The container blank preferably has a wall portion for forming a container wall and/or a neck portion for forming a removal opening. Preferably, a "container blank" in the sense of the present invention lacks a bottom. In particular the container blank is open towards at least one (axial) side. The bottom, thus, preferably is to be added for forming a container with the container blank.

A "bottle" in the sense of the present invention is preferably a closable container for transporting and storing fluids, particularly liquids, gases and pourable solids such as powders. A bottle in the sense of the present invention preferably has a diameter which is smaller than its height. A bottle in the sense of the present invention preferably has an at least substantially conically tapering end, also referred to as the neck of the bottle. The neck of the bottle preferably ends in an opening which is, in particular, round in cross section, closable and openable for the removal of its contents, also referred to as the removal opening. Bottles in the sense of the present invention are preferably narrow-necked bottles and/or vials. In narrow-necked bottles the diameter or the internal width of the removal opening is less than the average internal diameter of the storage space formed by the bottle, preferably less than 70 %, particularly less than 50 %. However, other solutions are also possible here.

A "base" or "bottom" in the sense of the present invention is preferably a part of a container being arranged remote of or opposite to an opening or closure or side on which content of the container can be added or removed.

A "removal opening" in the sense of the present invention is preferably an opening which can be opened in order to facilitate withdrawal of content from inside the container, or in order to put content inside the container.

A "closure" in the sense of the present invention is preferably a structure which seals in particular such that content inside the container is prevented from getting out of the container in a closed state. A closure further preferably is configured to be opened by means of which an opening is provided in order to enable content arranged or arrangeable inside the container to get out or be withdrawn from the container.

A "delivery state" or "initial state" in the sense of the present invention is preferably a configuration in which a device typically is delivered or sold or offered to be delivered or sold. In particular, a delivery state indicates that a container is closed and/or its integrity has not been set into a use state in which the container can be instantly used, in particular for withdrawal of content and/or mixing of contents.

A "connecting arrangement" in the sense of the present invention is preferably a means which is configured to provide the fluidic connection and, preferably, to provide a mechanical connection while forming the fluidic connection. In particular, it is a fluid coupling, a flange, a coupling member, an attachment member, a plug connection, a male and/or female connector, particularly a plug connector, or a part thereof.

A "connecting arrangement" in the sense of the present invention may be a portion/region of a container, particularly a bottle, or the connecting arrangement is (respectively) connected to a container, particularly by material, frictional and/or interlocking connection. Particularly preferably the connecting arrangement is at least partially formed by or in one piece with the container or the bottle. Alternatively or additionally the connecting arrangement adjoins a container or a bottle or is otherwise suitable for fluidically attaching or connecting the interior of the container or the bottle.

A connecting arrangement is preferably "fluidically sealed", in the sense of the present invention, when the escape or passage of fluid, particularly liquid, is prevented or when a fluid or liquid barrier prevents the escape or passage of fluid, particularly liquid.

Connecting arrangements "can be inserted into one another" in the sense of the present invention particularly when a part or portion of one of the connecting arrangements can be arranged inside the other connecting arrangement or a part or portion thereof. In particular, at least a portion of one of the connecting arrangements can be pushed, laid, inserted or otherwise introduced into the other or corresponding connecting arrangement. Connecting arrangements are inserted into one another particularly when they overlap radially at least partially, substantially and/or completely in relation to a (common) axis of symmetry and/or central axis, or an inner portion of the one connecting arrangement is (completely) surrounded or embraced (radially) by an outer portion of the other connecting arrangement.

A "tubular coupling arrangement" in the sense of the present invention is preferably a part or section or portion of a connecting arrangement that is formed in the shape of a neck and/or collar and/or a ring or as a tube section/section or tubular part, and is configured for facilitating a fluidic coupling, preferably of one with the other connecting arrangement.

The tubular coupling arrangement is preferably configured for producing, forming or surrounding or (laterally) delimiting the fluidic connection. The tubular coupling arrangement is particularly configured for conveying fluid after opening.

The tubular coupling arrangement may be closed in an initial state. In particular, the tubular coupling arrangement is closed off with a closure (plate), preferably so as to be openable once and/or irreversibly.

The tubular coupling arrangement may have an open or outer edge which in an initial or delivery state is closed, in particular by the closure which is preferably sealingly fixed to, arranged at or formed as are piece or integrally with the tubular coupling arrangement. Opening the tubular coupling arrangement preferably can be achieved by destructive separation of the closure from the tubular coupling arrangement.

The tubular coupling arrangement preferably surrounds the closure (plate) located inside the tubular coupling arrangement, i.e., the tubular coupling arrangement surrounds the closure. The term “surrounds” in the sense of the present invention preferably means in this context that the closure (in an initial state) is connected in a fluid-tight manner to the tubular coupling arrangement circumferentially or in some other way on all sides in the initial, delivery or closed state without established fluid connection.

Preferably, an optional closure of the mouth of the other connecting arrangement is pierceable or cuttable with the tubular coupling arrangement and/or with a cutting, severing, perforating or piercing element thereof. The tubular coupling arrangement may thus be configured as a tool for opening the mouth.

The tubular coupling arrangement preferably is configured for being deformed, so that the deformation causes breakage, bursting, tearing and/or detachment of the closure of the tubular coupling arrangement.

The mouth of the second coupling arrangement preferably is shaped corresponding to the tubular coupling arrangement and configured for deforming the tubular coupling arrangement, so that the deformation causes breakage of a thin point by means of which the closure (plate) is sealingly connected to the tubular coupling arrangement, particularly by rotation of the connecting arrangements relative to one another.

Particularly preferably, the tubular coupling arrangement is non-circular.

"Non-circular" in the sense of the present invention preferably means "non-circular" in cross-section. A cross-section is non-circular preferably if an outwardly facing silhouette or shape or line or tube wall forming the tubular coupling arrangement in its cross-section does not always result in the same shape when rotated about its tube axis. In other words, a non-circular tubular coupling arrangement is preferably not a solid od revolution, i.e., is not a shape obtains by rotating a place curve around some straight line. In particular, a non-circular tubular coupling arrangement is not cylindrical. Particularly preferably, non-circular is oval or elliptical (in cross-section). However, it can be polygonal or have another shape other than circular round as well, like an egg shape, for example. For example, a maximum and minimum radius (distance from tube axis or focus to wall or silhouette) of the same cross-section differ more than 10% or 20%, preferably more than 30%.

A "mouth-like portion" or a "mouth" in the sense of the present invention is in particular a portion or part which is comprises or forms an opening, an opening edge, an orifice, hole, or a short tube portion, preferably with an opening at its end, or some other tubular portion or a passage with a radially surrounding wall which terminates in an opening, which is preferably open at its end and/or forms an opening in at least one end.

A "mouth" can be stable in form in order to be able to act as a tool for deforming a tubular coupling arrangement, which is preferably more easily deformable (although it might be essentially stable in form as well) easier than the mouth such that when a mouth and a tubular coupling arrangement are acting on one another, primarily the tubular coupling arrangement is deformed while the mouth essentially keeps its form.

The tubular coupling arrangement and the mouth preferably correspond to each other such that they can be arranged one inside the other and are configured so that rotation of the connecting arrangements against one another leads to deformation of the tubular coupling arrangement, so as to break its closure.

Even more preferably, both the tubular coupling arrangement and the mouth are non-circular with a similar shape or cross section. The non-circular tubular coupling arrangement and the corresponding non-circular mouth preferably are similar in shape such that they can be placed inside one another when the non-circular shapes of the tubular coupling arrangement and the corresponding mouth are aligned but cannot be rotated relative to one another without deformation. Accordingly, the cross-sections upon rotation intersect such that the mouth deforms the tubular coupling arrangement. For that purpose, the mouth preferably is more rigid or stable in form than the tubular coupling arrangement.

The tubular coupling arrangement, although preferably being essentially stable in form as well, preferably is (elastically) deformable such that its cross-sectional shape is changed when the mouth acts on it. In particular, the tubular coupling arrangement is a tube portion which is at least partially thin-walled or weakened with properties like wall thickness and material such that it can be deformed accordingly.

The connecting arrangements preferably are constructed to produce the continuous fluidic connection (passage), preferably for the first time, by opening both connecting arrangements. Opening only one of the connecting arrangements or opening neither one nor the other connecting arrangement preferably results in a fluidic blockade or fluidic shut-off.

A continuous fluidic connection in the sense of the present invention means, in particular, that a passage is formed through which a fluid can flow. Preferably, this passage is formed by the mutual opening of the connecting arrangements (one opens the other and the other opens the one of the connecting arrangements).

In particular, the tubular coupling arrangement and the mouth may be configured such that, by pushing the tubular connecting arrangement into the mouth and rotating them against one another, preferably about an, in particular, common central axis, an outer side of the inwardly arranged tubular coupling arrangement comes into contact with the inner side of the outwardly arranged mouth, so that a force thus generated re-shapes or deforms at least the tubular coupling arrangement.

In particular, the tubular coupling arrangement and the mouth may each be non-circular, in particular oval, in cross-section and/or may fit inside one another in a similar orientation, at least to begin with, in order to bring about (mutual) deformation or re-shaping as rotation takes place. In this way, a longitudinal dimension of the cross-section of the tubular coupling arrangement may be compressed and/or a transverse dimension of the cross-section of the tubular coupling arrangement may be stretched or extended, thus causing a tensile fracture, burst, tear and/or detachment of its closure, resulting in its opening.

An "axial movement" or "translational movement" along a common axis or coupling axis in the sense of the present invention is preferably a movement which is non-helical, non-rotational, at least substantially or solely linear and/or solely axial and/or a movement which does not require a complete rotation or revolution. The connecting arrangements are preferably adapted to be fitted into one another, inserted in one another and/or fitted together in an at least substantially linear manner to produce the non-releasable and/or fluidic connection.

A "coupling axis" is a direction into which the connecting arrangements can be inserted into one another by merely translational relative movement.

An "axis of symmetry" preferably is an axis to which the shape of the tubular connecting arrangement and/or of the mouth (rotationally or axially) is symmetrical. Symmetrical is here to be understood as a discrete rotational symmetry to be certain degree or only about a certain angle. For example, an ellipse is rationally symmetric to the second degree or only about an angle of 180 ° (and multiples thereof). An equilateral triangle is rotationally symmetric to the third degree or only about an angle of 120 ° (and multiples thereof). However, (rotational) symmetric is preferably not to be understood as a continuous rational symmetry or about any angle like for a circle.

A "central axis" preferably is an axis which is in the center of a structure, in particular in the center of a tube.

A "tube axis" is the central axis or axis of symmetry of a tube or the tubular coupling arrangement. The tube axis can comply or coincide with the central axis, the axis of symmetry and/or the coupling axis. In particular, the tube axis is the axis along which the tube or tubular coupling arrangement extents or an axis of extension.

"Opening" in the sense of the present invention particularly denotes providing access to the interior of a container or a bottle or the volume contained by a container or bottle, by forming an opening, an orifice, a passage, a hole or the like, particularly such that a fluid, particularly a liquid, can enter and/or leave.

An "opening region" in the sense of the present invention is in particular a region which is configured for opening, i.e. is constructed so as to form an opening, an orifice, a passage, a hole or the like or fluidic access for the interior or for the volume contained by a container. The opening region is preferably fluidically closed and fluidically openable. It may be a closed off hole, a closed and openable wall orifice, a closed and openable passage, a closed and openable closure, a breakable base or the like.

"Pierceable" in the sense of the present invention is, in particular, a structure which can be broken through or perforated by means of an object, particularly a point, such that a connection can be made from one (flat) side to the opposite side. The piercing preferably produces an opening. In particular, a pierceable opening region is destroyed on piercing and permanently opened thereby.

A "fluidic connection" in the sense of the present invention is preferably a means configured for the passage of a fluid, particularly a liquid, a gas or a flowable solid. In particular it is a transit region, a passage or channel. A fluidic connection or passage is preferably sealed from the environment. In particular, it is a transit region, a connection or a channel which is preferably (tightly) sealed off from the environment or a side remote from the passage on a wall that forms the passage.

"Brittle" or "fragile" in the sense of the present invention is something, in particular a closure, which, on account of its composition and/or construction, is suitable for and designed to rupture close to its elastic limit without or with very little plastic deformation (brittle fracture). This can be provided as a thin point / section or another frangible point, which results in this.

A "frangible point", "thin point" or "frangible line" in the sense of the present invention is preferably a region which is mechanically fragile or less stable than the parts surrounding it and/or which can be destroyed manually or by the application of force, particularly by rupturing or breaking.

"Outside the opening region" in the sense of the present invention means that this is a region or portion which is separate from the opening region but is preferably directly or indirectly adjacent to the opening region, particularly such that deformation in this region causes stretching of the opening region.

"Deformable" in the sense of the present invention is preferably elastic or plastic deformability. The connecting arrangement(s), tubular coupling arrangements, and/or mouth-like portions are preferably elastically deformable, thus causing plastic/irreversible deformation of the opening region. The connecting arrangement(s) or mouth-like portions may, however, also be plastically deformed/deformable.

Parts or portions are said to be "corresponding to one another" in the sense of the present invention particularly when they are of similar and/or complementary construction to one another, when they fit into one another, resemble one another, are arranged similarly, have similarly oriented structures of similar shape and/or are configured to interact with one another in order to produce a function or effect.

"Rotating relative to one another" in the sense of the present invention denotes in particular a rotary movement of a part, preferably a connecting arrangement or a container or a bottle with a connecting arrangement, relative to another part, preferably another connecting arrangement or another container or another bottle.

"Rotating against one another" in the sense of the present invention denotes in particular a rotary movement of two parts, preferably a connecting arrangement or a container or a bottle with a connecting arrangement, relative to another part, preferably another connecting arrangement or another container or another bottle, preferably in different or opposite directions of rotation.

A "weakened region" in the sense of the present invention preferably is a structurally and/or mechanically region differing from regions surrounding it in facilitating or simplifying (elastic) deformation compared to a structure surrounding the weakened region. In particular, it can be more generally, a more flexible region, in particular due to thinning.

A "radial force" in the sense of the present invention is preferably a force in direction toward or from an axis and, in particular, having a direction being essentially perpendicular and/or intersecting said axis, in particular the axis of symmetry, the tube axis or coupling axis.

A "step portion" in the sense of the present invention is preferably a structure having at least one bend and preferably at least two bends in opposite direction, resulting in a shape like a doorstep or the like.

A "passage" in the sense of the present invention is preferably a connection between the interiors of the containers which enables content to move from one to the other container.

A "pressing element" in the sense of the present invention is preferably a structure being configured to act on something such that the something is pressed against something else.

"Radially offset inwards" in the sense of the present invention preferably means shifted in a radial direction, i.e., towards or away from an axis, in particular a tube axis, coupling axis and/or axis of symmetry.

A "bead" in the sense of the present invention is preferably a shape of a weak line surrounding a closing plate having an abrupt change in direction preferably bordering less abrupt changes in a different direction, resulting in a local edge and/or shear force extending structure.

A "beak" or "beak-shaped piercing section" in the sense of the present invention is preferably a piercing section of a cutting edge, which can have a shape of a peak, piercer, or spike and/or being pointed and/or protruding in comparison with a section of the cutting edge bordering the piercing section. The piercing section can be formed by an abrupt change in direction of the course of the cutting edge. The piercing section preferably borders ramps, resulting in a piercing section being a local edge and/or structure capable of producing shear forces.

A "bayonet catch" in the sense of the present invention is preferably a connecting means that, upon rotation, causes a form fitting connection by engaging behind structures.

A "closure plate" in the sense of the present invention is preferably a closure formed by or comprising a plate which closes off an opening or is configured to do so.

"Stiffening structures" in the sense of the present invention are preferably structures like ribs for stiffening that enhance the stiffness of something to which it is provided.

"Form-fitting elements" in the sense of the present invention are preferably structures that are configured for forming a form-fit connection.

A "circumferential wall" in the sense of the present invention is preferably a wall like that of a tube having in cross section a closed, preferably circular, shape.

A "rigid closure plate" in the sense of the present invention is preferably a closure plate which is configured to essentially not bend, preferably at least when used as usual or intended in the application where it is applied.

A "weakening" in a closure plate in the sense of the present invention is preferably a structure allowing a certain degree of deformation, preferably even when used as usual or intended in the application where it is applied.

A guide surface is "inclined" in the sense of the present invention preferably if it has a ramp effect and/or when a tangent at the guide surface has a component in a direction parallel to an axis, in particular a central axis, axis of symmetry or connecting axis, and, preferably applies force to something guided at the surface in the direction of the axis, in particular central axis, axis of symmetry or connecting axis.

An "inwardly facing circumferential sealing surface" is a surface which faces inwardly like the inner surface of a tube or hollow cylinder, preferably having a circular cross-section and/or being configured to act as or with a seal to form a sealing.

An "outwardly facing circumferential sealing surface" is a surface which faces outwardly like the outer surface of a tube or (hollow) cylinder, preferably having a circular cross-section and/or being configured to act as or with a seal to form a sealing.

The aspects of the present invention mentioned above and described in the following specific description may also be implemented and advantageous individually and in various combinations.

Further aspects, advantages and properties of the present invention will become apparent from the following description of preferred embodiments in conjunction with the accompanying drawings.

### BRIEF DESCRIPTION OF THE DRAWINGS

FIG. 1 shows a longitudinal section through a container comprising the proposed first connecting arrangement before the coupling;

FIG. 2 shows a longitudinal section through a container comprising the proposed second connecting arrangement before the coupling;

FIG. 3 is a perspective view of the first connecting arrangement;

FIG. 4 is a perspective view of the second connecting arrangement;

FIG. 5 shows a longitudinal section through the container system comprising the proposed connecting system in a first connecting position;

FIG. 6 shows a longitudinal section through the container system comprising the proposed connecting system in a second connecting position;

FIG. 7A shows a longitudinal section through a container system with the proposed connecting system and with the fluidic connection made;

FIG. 7B shows a longitudinal section through a container system with the proposed connecting system and with the fluidic connection made;

FIG. 8 shows a longitudinal section through the proposed connecting system in another embodiment in the first connecting position;

FIG. 9 shows a section of the connecting system in the region of the sealing arrangement;

FIG. 10 shows a section of the connecting system in the region of the sealing arrangement;

FIG. 11 is a perspective view of a third connecting arrangement;

FIG. 12 is a perspective view of a closure cap of the third connecting arrangement;

FIG. 13 is a perspective view of a fourth connecting arrangement;

FIG. 14 is a perspective view of a closure cap of the fourth connecting arrangement;

FIG. 15 shows a cross section through the first connecting arrangement;

FIG. 16 shows a longitudinal section through the proposed connecting system in the first connecting position;

FIG. 17 is a perspective view of an alternative embodiment of the proposed connecting arrangement;

FIG. 18 is a perspective view of an alternative of the closure cap of the alternative embodiment of the proposed connecting arrangement;

FIG. 19 shows a combination of the connecting arrangement according to FIG. 17 and the closure cap according to FIG. 18 while the closure cap is cut away partially; and

FIG. 20 is a cross sectional view of the combination of the connecting arrangement and the closure cap according to FIG. 19 along a cutting plane based on the cutting plane used for FIG. 19 moved slightly radially inwardly, thus showing engaged blocking elements.

### DETAILED DESCRIPTION OF THE INVENTION

In the following description of preferred embodiments by reference to the drawings, the same or corresponding reference signs have been used for the same or similar components or parts, where similar or identical advantages and properties may be achieved even if the associated description has not been repeated.

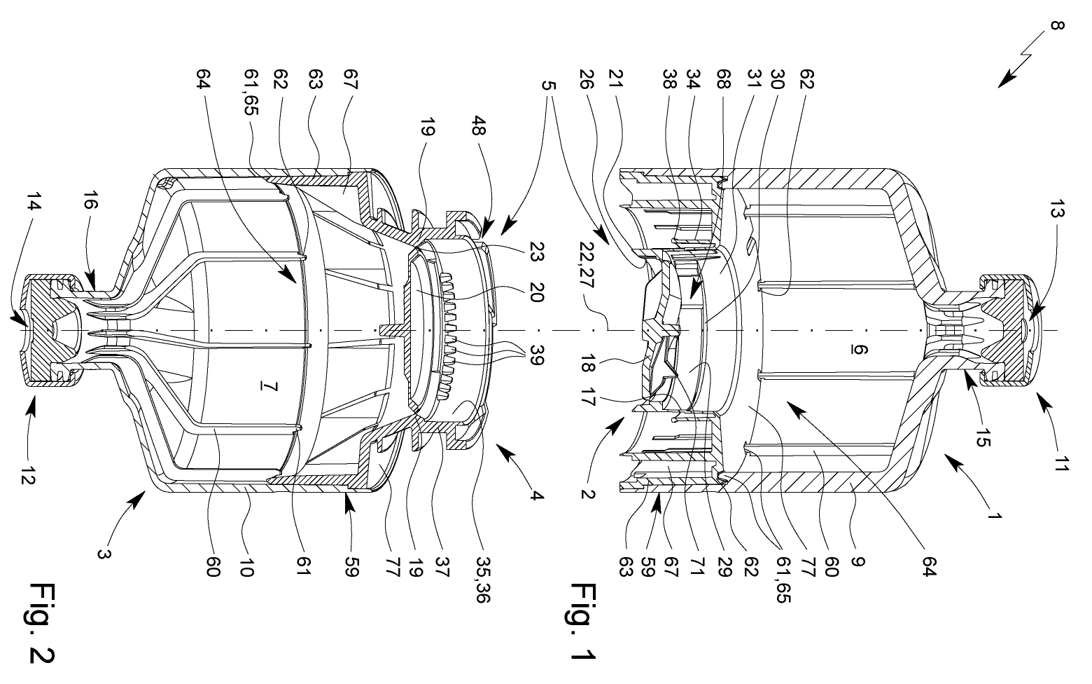

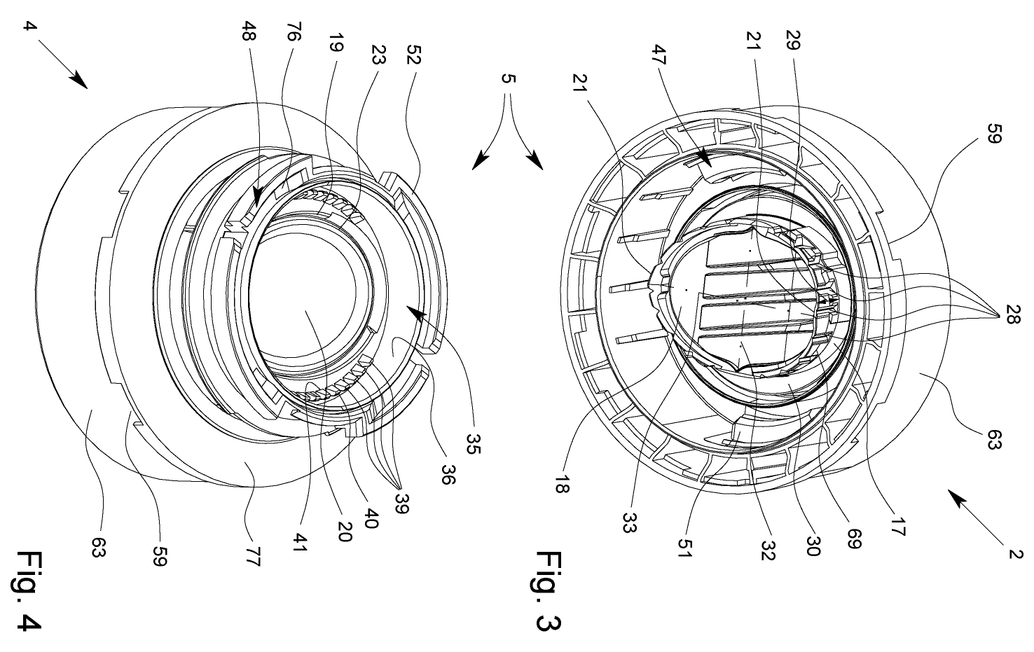

FIG. 1 shows a longitudinal section through a proposed first container 1 comprising a proposed first connecting arrangement 2 and FIG. 2 shows a longitudinal section

through a proposed second container 3 comprising a proposed second connecting arrangement 4. The combination of the first connecting arrangement 2 and the second connecting arrangement 4 forms the proposed connecting system 5.

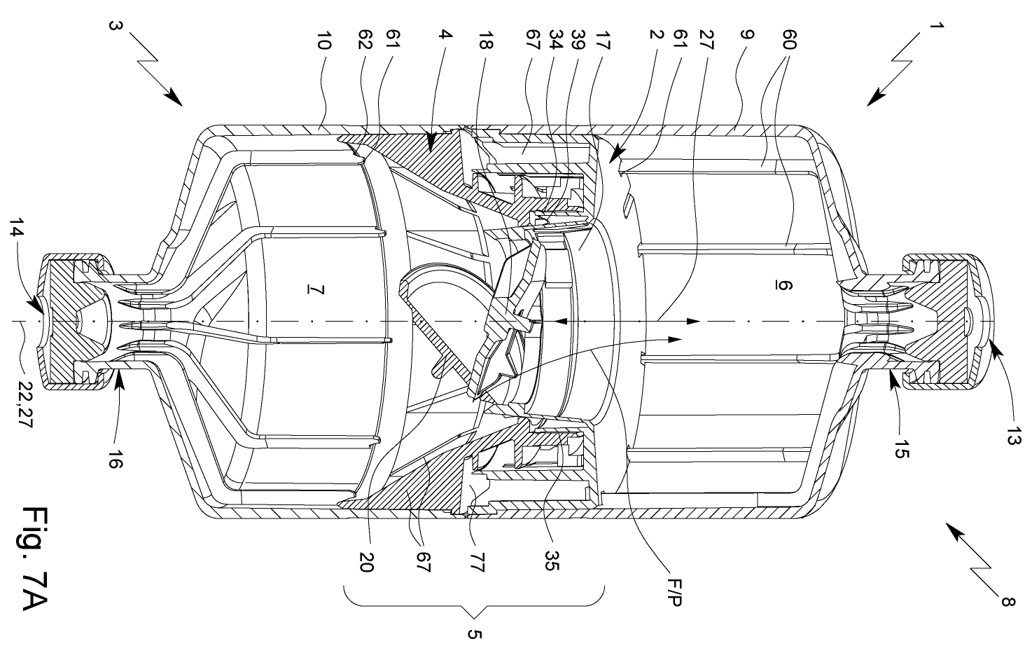

The proposed connecting system 5 is designed to produce a fluidic connection F or passage P which is suitable for fluidically connecting an interior 6 of the first container 1 to an interior 7 of the second container 2. The passage P is indicated in FIGS. 7A and 7B by the arrow F/P. This will be discussed in greater detail in connection with the discussion of FIGS. 7A and 7B.

In this case, the connecting system 5 is configured to produce a fluidic connection F between the first container 1 and the second container 3. The containers 1, 3 together preferably form a container system 8.

However, the first connecting arrangement 2, the second connecting arrangement 4 and/or the connecting system 5 can also be implemented independently of the first container 1 and/or the second container 3. It should be noted here that the first container 1 may be formed from a first container blank 9 and the first connecting arrangement 2, but the first connecting arrangement 2 may also be implemented separately and used in a different way. The same applies to the second container 3, which may be formed from a second container blank 10 and the second connecting arrangement 4, but the second connecting arrangement 4 may also be implemented separately and used in a different way.

In the example shown, the first container 1 has a removal opening 11, which can provide access to the interior 6 of the first container 1 for the purpose of removing contents. In the example shown, the second container 3 also has a removal opening 12, which can provide access to the interior 7 of the second container 3 for the purpose of removing contents. At least in one of the containers 1, 3, the removal opening 11, 12 may be omitted.

The removal openings 11, 12 more preferably each have a removal opening closure 13, 14, in particular what is known as a septum.

Furthermore, the containers 1, 3 are bottles in the example shown. These have a bottle neck 15, 16 adjacent to the relevant removal opening 11, 12.

The first connecting arrangement 2 preferably comprises a tubular coupling arrangement 17. The coupling arrangement 17 is closed by a closure 18 in a delivery state or initial state. In the example shown, the closure 18 is formed by a closure plate. However, this is not absolutely necessary in each case.

The second connecting arrangement 4 preferably comprises a mouth 19 which, in a delivery state or initial state, is preferably closed by a closure 20. This is not necessarily the case. In principle, it is namely also possible for the second connecting arrangement 4 to have a mouth 19 that is not closed.

The coupling arrangement 17 of the first connecting arrangement 2 preferably comprises a cutting edge 21. The cutting edge 21 is designed to open the closure 20 of the second connecting arrangement 4. For this purpose, the cutting edge 21 can act on the closure 20 of the second connecting arrangement 4, particularly preferably in a separating manner, such that the second closure arrangement 4 is opened and the mouth 19 is exposed.

The first connecting arrangement 2 and the second connecting arrangement 4 can preferably be coupled by being inserted into one another along a coupling axis 22. The corresponding cutting edge 21 and closure 20 or mouth 19 are preferably of the type whereby the cutting edge 21 and closure 20 or mouth 19 have a similar shape and orientation, such that a translational movement of the first connecting arrangement 2 relative to the second connecting arrangement 4 results in the cutting edge 21 perforating the closure 20 and thus producing or exposing the mouth 19.

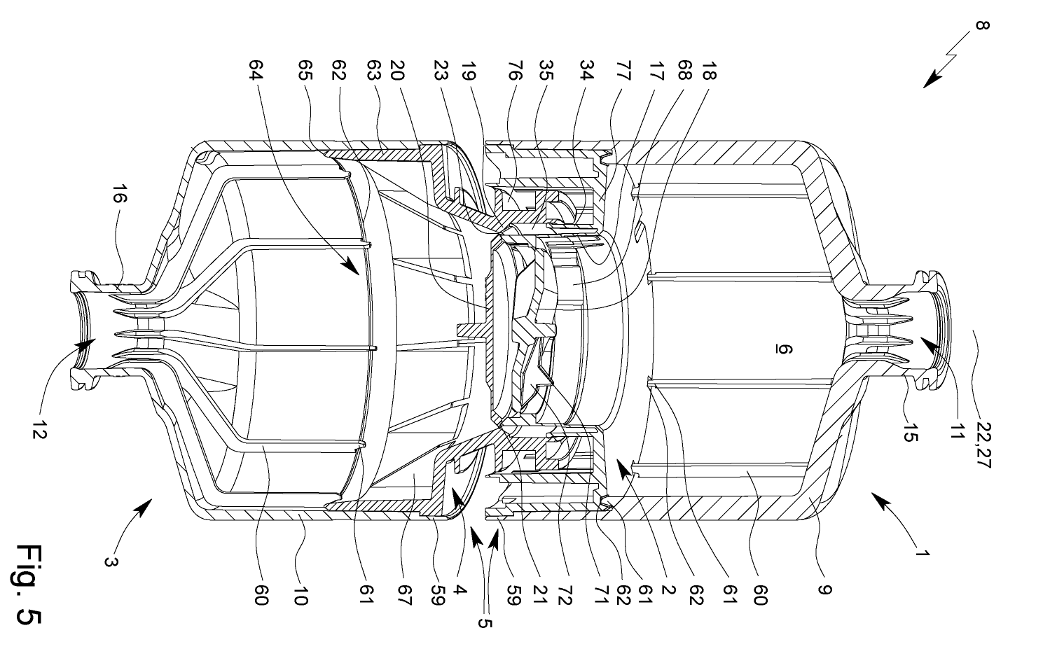

FIG. 3 is a perspective view of the first connecting arrangement, and FIG. 4 is a perspective view of the second connecting arrangement, specifically from an outside view or from a side facing away from the respective interior 6, 7 of an associated container 1, 3, respectively.

The closure 20 of the second connecting arrangement 4 preferably has a frangible point 23, in particular in the form of a line of weakness. In the example shown, the closure 20 is formed by a closure plate, which is circumferentially delimited by the frangible point 23.

The cutting edge 21 preferably corresponds to the frangible point 23. In particular, the course of the cutting edge 21 corresponds at least in portions to the line of weakness formed by the frangible point 23.

For producing the fluidic connection F, the first connecting arrangement 2 is preferably coupled to the second connecting arrangement 4 by being moved translationally relative to one another and thereby being inserted into one another. In any case, the second connecting arrangement 4 is preferably partially received by the first connecting arrangement 2, or vice versa.

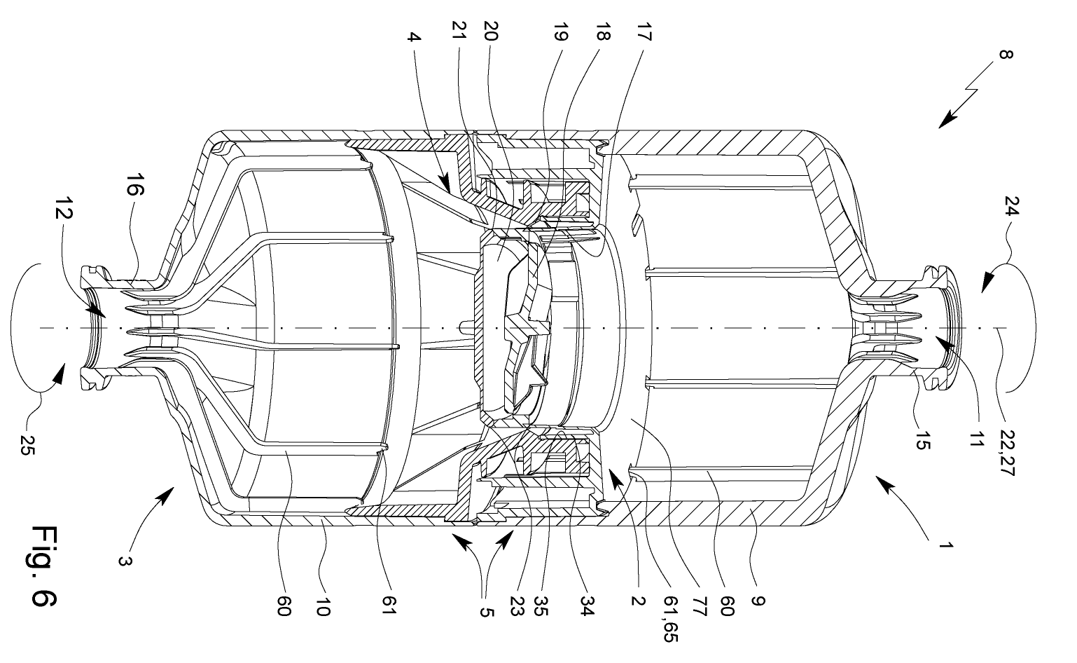

FIG. 5 shows a longitudinal section through the container system 8 comprising the proposed connecting system 5 in a first connecting position. In this connecting position, the first connecting arrangement 2 and the second connecting arrangement 4 are partially inserted into one another. In this connecting position, the first connecting arrangement 2 can be locked to the second connecting arrangement 4, preferably in a non-detachable manner. The cutting edge 21 is at least partially opposite the frangible point 23, but does not yet separate it in the first connecting position shown in FIG. 5.

FIG. 6 shows a longitudinal section through the container system 8 comprising the proposed connecting system 5 in a second connecting position. In this connecting position, the cutting edge 21 of the first connecting arrangement 2 has penetrated the frangible point 23 of the second connecting arrangement 4. For this purpose, the first connecting arrangement 2 and the second connecting arrangement 4 have been further inserted into one another translationally, such that the cutting edge 21 has a separating effect on the frangible point 23 and has caused the mouth 19 of the second closure arrangement 4 to be opened or exposed.

As indicated in FIG. 6 by the directional arrows 24, 25 extending in the opposite direction, the connecting arrangements 2, 4 or associated containers 1, 3 are now rotated relative to one another about the coupling axis 22. At this point in time, the coupling arrangement 17 of the first connecting arrangement 2 is surrounded by the mouth 19 of the second connecting arrangement 4.

The coupling arrangement 17 and the mouth 19 are complementary to one another and are non-circular, in the example shown oval, in cross section perpendicularly to the coupling axis 22. As a result, a rotation of the connecting arrangements 2, 4 relative to one another about the coupling axis 22 brings about preferably elastic deformation of the coupling arrangement 17.

FIG. 7A shows a longitudinal section through a container system with the proposed connecting system and with the fluidic connection made after the connecting arrangements 2, 4 having been rotated relative to one another. The rotation causes the coupling arrangement 17 to have deformed such that the closure 18 has broken due to the distortion caused by the deformation and thereby has caused an opening in the first connecting arrangement 2.

The connecting arrangements 2, 4 are preferably rotatable between a first position, which corresponds to the position of the connecting arrangements 2, 4 after they have been translationally inserted into one another without rotation, and an end position. The connecting arrangements 2, 4 are preferably rotatable relative to one another by at least substantially 90 degrees.

In FIG. 7A, the rotation is partial, in particular approximately 60 degrees. This is sufficient to form a passage P of which the opening width is increased by means of further rotation and the associated deformation of the coupling arrangement 17.

FIG. 7B shows a longitudinal section through a container system with the proposed connecting system and with the fluidic connection F made, according to which the connecting arrangements 2, 4 have been further rotated relative to one another or as far as a stop or up to an end position, in particular by approximately 90 degrees. The rotation causes the coupling arrangement 17 to have deformed such that the closure 18 has broken due to the distortion caused by the deformation and thereby has caused an opening in the first connecting arrangement 2. Compared with the partial rotation of the connecting arrangements 2, 4 relative to one another, as for example shown in FIG. 7A, the opening width of the passage P is increased.

As for example shown in FIG. 7B by the arrow F/P, the fluidic connection F or passage P has been formed by the opening in the first connecting arrangement 2. Through the passage P, the contents of the interior 6 of the first container 1 can now reach the interior 7 of the second container 3, and vice versa. Accordingly, the contents can be mixed.

In principle, it is possible for the first connecting arrangement 2 or the first container 1 comprising said connecting arrangement to be implemented independently of the second connecting arrangement 4. The proposed coupling arrangement 17 may then in principle be used in another connection for the cutting opening and/or may be used to make it possible to open the closure 18 by deformation of the coupling arrangement 17. It is clear that the combination of the first connecting arrangement 2 and the second connecting arrangement 4 corresponding thereto as the connecting system 5 is nevertheless particularly preferred.

The cutting edge 21 is arranged at an open end 26 of the tubular coupling arrangement 17 like depicted in FIG. 1. This is suitable for opening the second connecting arrangement by means of a translational relative movement of the connecting arrangements 2, 4 along a coupling axis 22, regardless of whether a second connecting arrangement 4 is also provided.

Preferably, the tubular coupling arrangement 17 comprises a tube axis 27, which preferably corresponds to the coupling axis 22. The tube axis 27 is preferably an axis of symmetry of the at least substantially tubular coupling arrangement 17. The coupling arrangement 17 may therefore be rotationally symmetrical about the tube axis 27 or the coupling axis 22. Regardless, the coupling arrangement 17 is preferably non-circular in cross section perpendicularly to the coupling axis 22 or tube axis 27. In the example shown, the coupling arrangement 17 is oval with axial symmetry to the coupling axis 22 or tube axis 27.

As can be clearly seen in particular in FIG. 3, the coupling arrangement 17 preferably has at least one weakened region 28 which enables or facilitates deformation of the coupling arrangement 17 radially relative to the coupling axis 22.

As already explained, the first connecting arrangement 2 is preferably opened by the coupling arrangement 17 being deformed and by the closure 18, which is surrounded by the coupling arrangement 17, being opened. In this connection, it has been found that the torque required for rotating the connecting arrangements 2, 4 can be reduced and thus the ease of opening can be improved if deformability of the coupling arrangement 17 required for opening the first connecting arrangement 2 is made easier. In the present case, this is made possible in particular by the weakened region(s) 28.

In order to fulfil its function, the coupling arrangement 17 preferably has sufficient stability, in particular in the coupling direction 17 along the coupling axis 22. By means of the weakened region(s) 28, easy deformability is nevertheless advantageously achieved radially relative to the coupling axis 22, and therefore easy opening is made possible.

Particularly preferably, the weakened region(s) 28 is/are formed by one or more notches. The notches in the form of weakened regions 28 have proven to be particularly suitable.

Preferably, the one or more notches extend at least substantially in parallel with the coupling axis 22. This advantageously allows for weakening of the coupling arrangement 17 primarily in the radial direction, while sufficient stability remains in the coupling direction.

The weakened region(s) 28 and in particular the notch or notches are preferably formed by a reduction in wall thickness in the radial direction with respect to the coupling axis 22. As can be clearly seen in the example shown, the notches are preferably formed on a radially outer side. Alternatively or additionally, however, notches may also be formed on an inner side.

The weakened region(s) 28 is/are preferably provided on a side of the interior 6 of the associated container 1 facing away from the closure 18, in particular the closure plate.

The weakened region(s) 28, in particular the notches, preferably extend(s) as far as the cutting edge 21 such that the cutting edge 21 is interrupted by the notches.

The weakened regions 28 thus preferably extend along a first portion 29 of the coupling arrangement 17 from the height of the closure 18 towards an open edge or the cutting edge 21 of the coupling arrangement 17.

In particular, the weakened region(s) 28 extend(s) in an elongate and/or uninterrupted form as far as the cutting edge 21 and interrupt(s) the course of the cutting edge 21 that otherwise corresponds at least substantially to the course of the frangible point 23. In this way, a tooth-like structure of the cutting edge 21 can be formed.

Preferably, a plurality of notches distributed along a circumferential line or surface of the coupling arrangement 17 are provided in the form of weakened regions 28. In this way, a weakening of the coupling arrangement 17 with regard to radial deformation relative to the coupling axis 22 can be achieved at least substantially along the entire circumferential line or surface of the coupling arrangement 17.

In order to open the first connecting arrangement 2, deformation of the coupling arrangement 17 along the entire circumferential line or surface is furthermore preferred in order to make it possible to securely open the closure 18. Therefore, the corresponding, at least substantially more uniform or equidistant distribution of the weakened regions 28 is also preferred. In the example shown, preferably more than 6, in particular more than 12 and/or less than 100, preferably less than 50 weakened regions 28 or notches are provided.

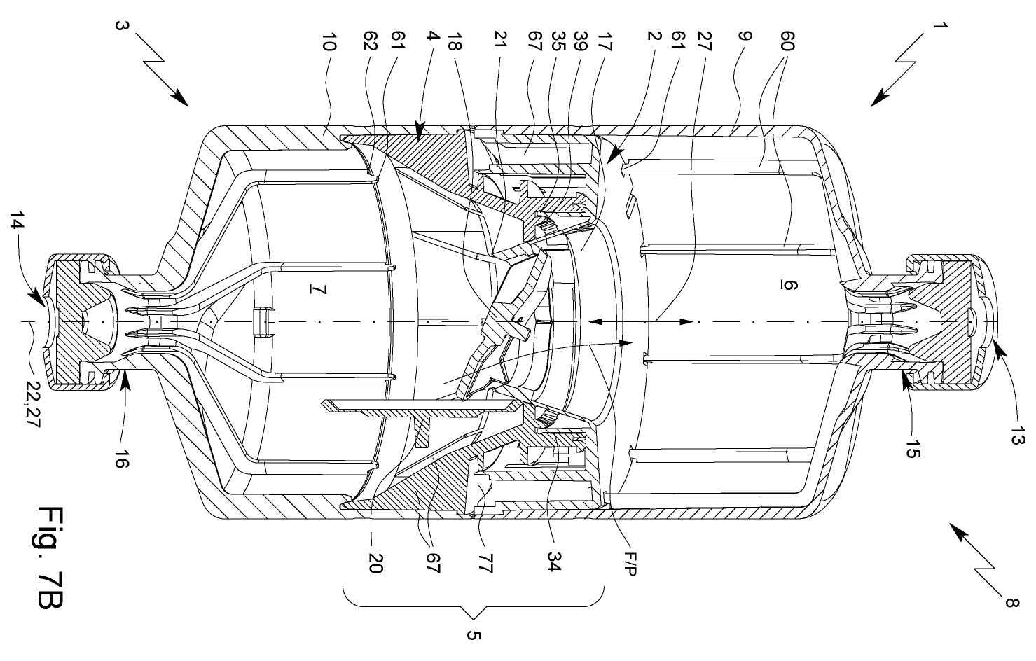

FIG. 8 shows a longitudinal section through the proposed connecting system 5 in another embodiment in the first connecting position. In this figure, the step portion 30 is clearly visible. In addition, reference is made in particular to FIG. 1.

The tubular coupling arrangement 17 preferably comprises a step portion 30 that extends substantially radially or perpendicularly relative to the tube axis 27 and is arranged between the first portion 29 extending at least substantially in parallel with the tube axis 27 and a second portion 31 extending at least substantially in parallel with the tube axis 27. In this case, the first portion 29 preferably connects one end of the step portion 30 to the cutting edge 21. The second portion 31 in turn preferably connects the step portion 30 to a structure of other parts of the first connecting arrangement 2.

In other words, the coupling arrangement 17 has a tubular shape, which has a step portion 30 which changes the diameter or the clear width of the coupling arrangement 17 between the first portion 29 and the second portion 31.

In the example shown, the step portion 30 adapts the shape of the tubular coupling arrangement 17, which is non-circular in cross section, to a circular shape of the surrounding structure. The step portion 30 may be formed in one piece or in several pieces. In the example shown, the step portion is formed on opposite sides of the coupling axis 22 in an axially symmetrical, rotationally symmetrical and/or interrupted manner.

The step portion 30 preferably forms a bellows together with the portions 29, 31 of the coupling arrangement 17 adjacent thereto. A bellows is a structure that is airtight and is flexible by means of one or more folds. In the present case, the airtightness is achieved by an uninterrupted, continuous wall, which is formed by the coupling arrangement 17. Furthermore, the step portion 30 creates kinks relative to the adjacent portions 29, 31. In particular radial deformation of the coupling arrangement 17 is thereby facilitated.

As already explained above, the coupling arrangement 17 is preferably non-circular in cross section, as a result of which it preferably has at least one first half-axis 32 having a minimum length and at least one second half-axis 33 having a maximum length which preferably intersect the coupling axis 22 and the tube axis 27, respectively, like shown in FIG. 3. In this connection, it is preferred that the step portion 30 has a greater extension in alignment with the first half-axis 32 than in alignment with the second half-axis 33. In this way, simpler radial deformability of the coupling arrangement 17 can be made possible.

This is because the step portion 30 makes deformability of the coupling arrangement 17 possible by stretching, preferably while changing, in particular decreasing or increasing, an angle φ enclosed by the step portion 30 and the first portion 29 and/or the second portion 31 of the coupling arrangement 17, with less force being required than in structures such as a cone or a continuously tubular course of the coupling arrangement 17 without an offset in the tube wall or a wall 66 of the coupling arrangement 17 due to such a step portion 30.

Using other words, the step portion 30 facilitates (better) deformability of the coupling arrangement 17. This can be achieved by the step portion 30 to be stretchable. Stretching preferably means that an angle φ enclosed by the step portion 30 and the first portion 29 and/or the second portion 31 of the coupling arrangement 17 is or are increased. Alternative or additionally, stretching means that the step portion 30, the first portion 29 and/or the second portion 31 is or are bended. This can cause to lengthen the structure comprised by or consisting of the step portion 30, the first portion 29 and/or the second portion 31. Fortunately, this enables deformation of the coupling arrangement 17 to become easier, i.e., less force is required compared to other construction structures such as a cone or a continuously tubular course of the coupling arrangement 17, such other construction structures not having the advantageous offset in the tube wall or a wall 66 of the coupling arrangement 17 due to such a step portion 30 facilitating stretching thereof.

In particular, the step portion 30 in alignment with the first half-axis 32 forms a bellows having the above-described properties, and this does not necessarily have to be the case in alignment with the second half-axis 33 and is also not the case in the example shown.

This is because it is preferably provided that the step portion 30 tapers in the direction of the alignment with the second half-axis, and specifically in particular tapers to zero, such that a step portion 30 is not provided in alignment with the second half-axis 33. This makes it possible both to increase the flexibility of radial deformability of the coupling arrangement 17 as well as to adapt the outwardly facing circumferential surface which is non-circular in cross section or the non-circular wall course of the coupling arrangement 17 to a circular cross section, which the coupling arrangement 17 may have in the second portion 31.

It is thus provided in particular that the radial extension of the step portion 30, proceeding from the extension or alignment with the second half-axis 33, increases, in particular continuously, on either side in the direction of the extension or alignment with the first half-axis 32. In this way, it can be achieved that the step portion 30 adapts the shape of the coupling arrangement 17, which is non-circular in cross section, to a circular shape.

As a result, the step portion 30 connects the second (tube) portion 31 of the coupling arrangement 17 having a circular cross section to the first (tube) portion 29 of the coupling arrangement 17, which is non-circular in cross section.

The step portion 30 lies at least substantially in a plane which is perpendicular to the coupling axis 22 or tube axis 27.

The first portion 29 of the coupling arrangement 17 is preferably formed by an oval tube, while the second portion 31 of the coupling arrangement 17 is preferably formed by a circular tube, such that the step portion 30 extends preferably at least substantially radially between the oval tube outer surface of the first portion 29 of the coupling arrangement 17 and the circular tube portion of the second portion 31 of the coupling arrangement 17.

The first connecting arrangement 2 preferably comprises a tubular sealing arrangement 34 and the second connecting arrangement 4 comprises a receptacle 35 that is complementary to the tubular sealing arrangement 34 such that the tubular sealing arrangement 34 can be inserted into the receptacle 35 by means of a translational relative movement of the connecting arrangements 2, 4 along the coupling axis 22. This can be seen in particular in FIGS. 1, 2 and 5-7.

The receptacle 35 and the sealing arrangement 34 are preferably circular in cross section perpendicularly to the coupling axis 22 and comprise mutually corresponding surfaces, preferably an in particular inwardly facing circumferential sealing surface 36 and/or an in particular outwardly facing circumferential sealing surface 38, which abut one another when the connecting arrangements 2, 4 are inserted into one another.

Accordingly, the inwardly facing circumferential sealing surface 36 is a surface facing inwardly while the outwardly facing circumferential sealing surface 38 is a surface facing outwardly, and, preferably, when assembled the outwardly facing circumferential sealing surface 38 is enclosed by the inwardly facing circumferential sealing surface 36.

As a result, the fluidic connection F or passage P to be formed can be sealed with respect to the environment.

With reference to FIGS. 1 and 2, the sealing arrangement 34 is tubular. The sealing arrangement 34 is preferably formed or aligned around the coupling arrangement 17 and/or at least substantially coaxially therewith. In particular, the sealing arrangement 34 and the second portion 31 of the coupling arrangement 17 are formed by coaxially extending circular tube portions. In this case, the sealing arrangement 34 preferably surrounds the coupling arrangement 17, i.e. it has a larger diameter. The sealing arrangement 34 is preferably set back relative to the coupling arrangement 17 axially or in the direction of the coupling axis 22 or tube axis 27. In other words, the coupling arrangement 17 protrudes beyond the sealing arrangement 34, in particular by its first portion 29 and/or in the region of the cutting edge 21.

The receptacle 35 preferably comprises the inwardly facing circumferential sealing surface 36, which may have the shape of a hollow cylindrical jacket. The inwardly facing circumferential sealing surface 36 may in this case be formed by a tubular wall 37 of the second connecting arrangement 4.

The sealing arrangement 34 preferably comprises or forms an outwardly facing circumferential sealing surface 38. The outwardly facing circumferential sealing surface 38 preferably corresponds to the inwardly facing circumferential sealing surface 36 such that, when coupling, the outwardly facing circumferential sealing surface 38 comes into sealing contact with the inwardly facing circumferential sealing surface 36.

Preferably, the inwardly facing circumferential sealing surface 36 and the outwardly facing circumferential sealing surface 38 are arranged coaxially with the coupling axis 22 and are circular in cross section, such that the connecting arrangements 2, 4 can rotate about the coupling axis 22 without existing contact between the inwardly facing circumferential sealing surface 36 and the outwardly facing circumferential sealing surface 38 being interrupted.

The second connecting arrangement 4 preferably comprises one or more pressing elements 39 that are preferably radially offset inwards with respect to the coupling axis 22 relative to the inwardly facing circumferential sealing surface 36 of the receptacle 35 in order to press the outwardly facing circumferential sealing surface 38 of the tubular sealing arrangement 34 against the inwardly facing circumferential sealing surface 36 of the receptacle 35.

In particular, the pressing elements 39 are arranged and designed such that, during coupling of the connecting arrangements 2, 4, in particular while the connecting arrangements 2, 4 are being translationally inserted into one another, the sealing arrangement 34 in the region of an open end or an open edge is or has been inserted between the outwardly facing circumferential sealing surface 38 and the pressing elements 39.

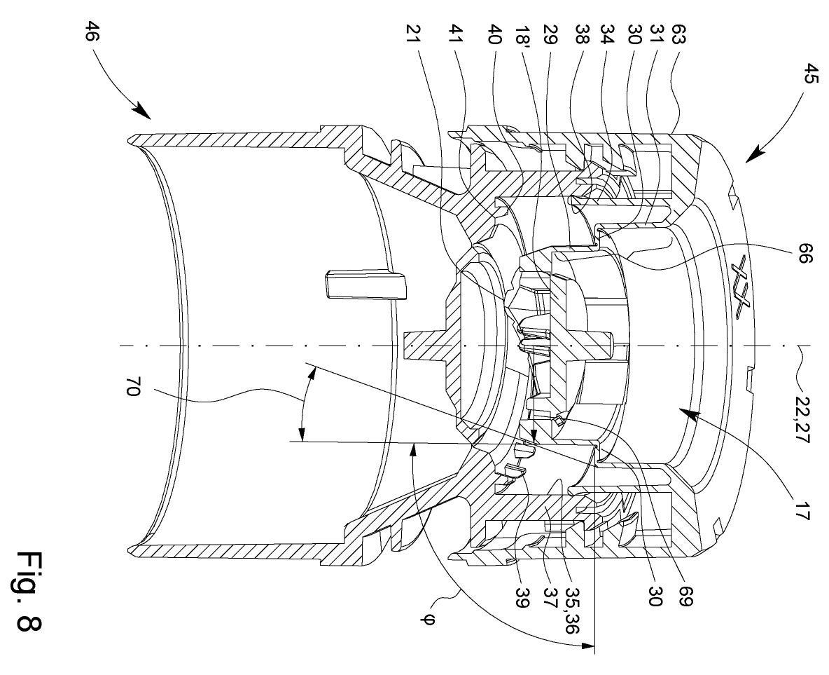

FIGS. 9 and 10 each show a detail of the connecting system 5 in the region of the sealing arrangement 34, specifically in FIG. 9 in the position of the connecting arrangements 2, 4 relative to one another before rotation, i.e., in FIG. 6, in the second connecting position shown in another sectional plane and, in FIG. 10, in the position of the connecting arrangements 2, 4 relative to one another after rotation, i.e. in the third connecting position shown in FIGS. 7A and 7B in which the fluidic connection F or passage P is produced.

In the rotational position of the connecting arrangements 2, 4 relative to one another in which the translational movement into one another is possible, it may be provided that the pressing elements 39 have play relative to a side facing away from the outwardly facing circumferential sealing surface 38, as for example shown in FIG. 9. Furthermore, it may be provided that the pressing elements 39 press the outwardly facing circumferential sealing surface 38 against the inwardly facing circumferential sealing surface 36 for a more secure sealing effect by exerting pressure on the sealing arrangement 34 on a side facing away from the outwardly facing circumferential sealing surface 38, at least after rotation of the connecting arrangements 2, 4 relative to one another for opening the first connecting arrangement 2 and/or the coupling arrangement 17, as for example shown in FIG. 10.

The tubular sealing arrangement 34 preferably has different wall thicknesses at an open edge along a circumferential line / surface. As a result, it can be achieved that, when the connecting arrangements 2, 4 are inserted into one another, there is play between the pressing elements 39 and the receptacle 35, which, however, disappears when the connecting arrangements 2, 4 are rotated relative to one another about the coupling axis 22.

The coupling arrangement 17 preferably has, as already explained, a tube axis 27, which preferably corresponds to the coupling axis 22. The coupling arrangement 17 is more preferably closed in an original state and being openable to form the passage P by deforming the coupling arrangement 17 transversely to its tube axis 27. For this purpose, the coupling arrangement 17 is preferably non-circular in cross section. Accordingly, in its cross section, it preferably has the at least one first half-axis 32 having a minimum length and the at least one second half-axis 33 having a maximum length (cf. for example FIG. 3). In this case, with respect to the wall thickness of the sealing arrangement 34, it is preferred that the tubular sealing arrangement 34 has a lower / smaller wall thickness in alignment or extension with the first half-axis 32 than in alignment with the second half-axis 33.

The pressing element(s) 39 is/are preferably one or more pins extending at least substantially in parallel with the coupling axis. The pin or pins may have a radially outwardly directed contact surface 40. By means of this contact surface 40, pressure can be exerted on a radially inner surface or on the side of the coupling arrangement 17 facing away from the outwardly facing circumferential sealing surface 38 which presses the outwardly facing circumferential sealing surface 38 against the inwardly facing circumferential sealing surface 36.

The contact surface 40 may be spaced apart from a foot point 41 of the pin or the respective pins. The contact surface 40 preferably protrudes radially outwards, such that an undercut 42 results between the contact surface 40 and the foot point 41 of the pin in the direction of the coupling axis 22 or tube axis 27.

The first connecting arrangement 2 preferably comprises a bead 43 along the outwardly facing circumferential sealing surface 38 of the tubular sealing arrangement 34, which bead has an oversize relative to the inwardly facing circumferential surface 36 of the receptacle 35. Preferably, the bead 43 forms the outwardly facing circumferential sealing surface 38 in the form of an uninterrupted sealing surface on a radially outwardly facing circumferential line of the sealing arrangement 34.

The bead 43 preferably has an oversize relative to a clear width 44 between the outwardly facing circumferential sealing surface 38 and the one or more pressing elements 39. In this way, a sealing effect can be ensured, even if deformation of the coupling arrangement 17 should result in stresses in the material of the sealing arrangement 34.

The pressing element(s) 39 exert a radial pressure on the sealing arrangement 34 in the coupled state of the connecting arrangements 2, 4, by means of which the sealing arrangement 34 is brought with the outwardly facing circumferential sealing surface 38 into tight contact with the inwardly facing circumferential sealing surface 36 of the receptacle 35.

In this case, the bead 43 is preferably formed at an open end of the tubular sealing arrangement 34.

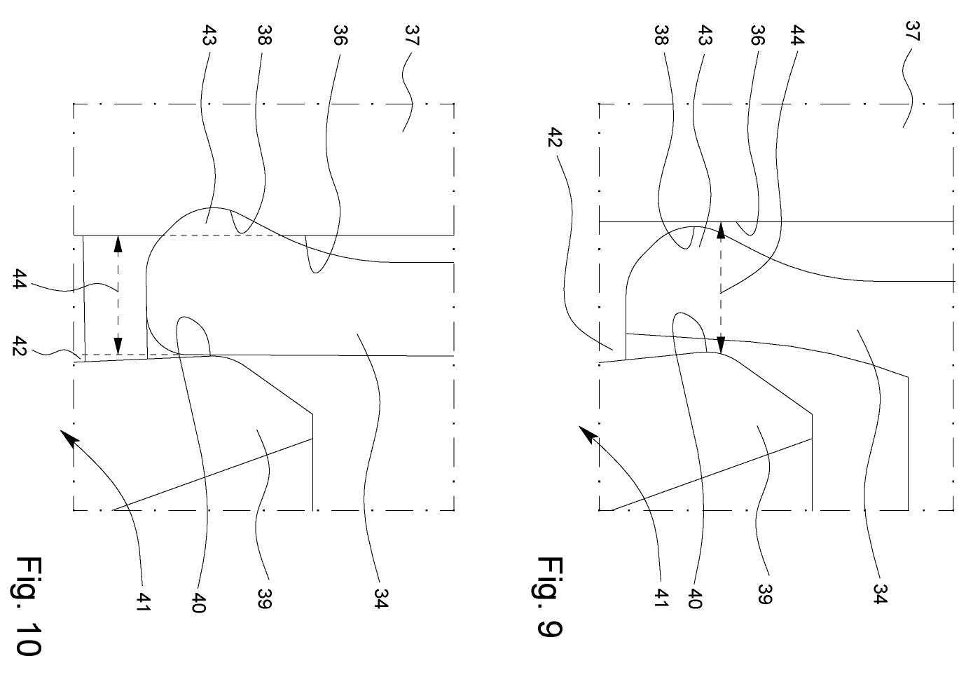

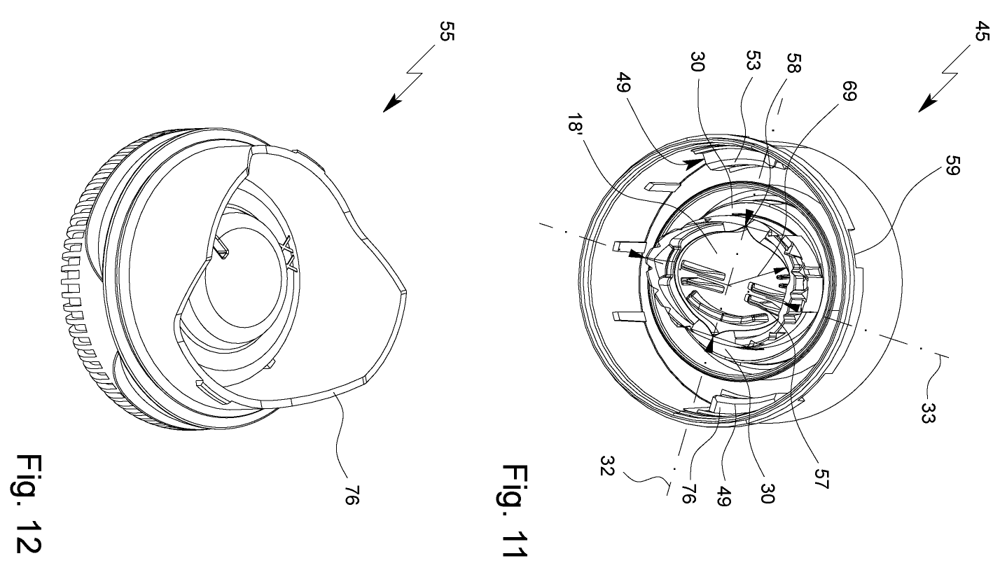

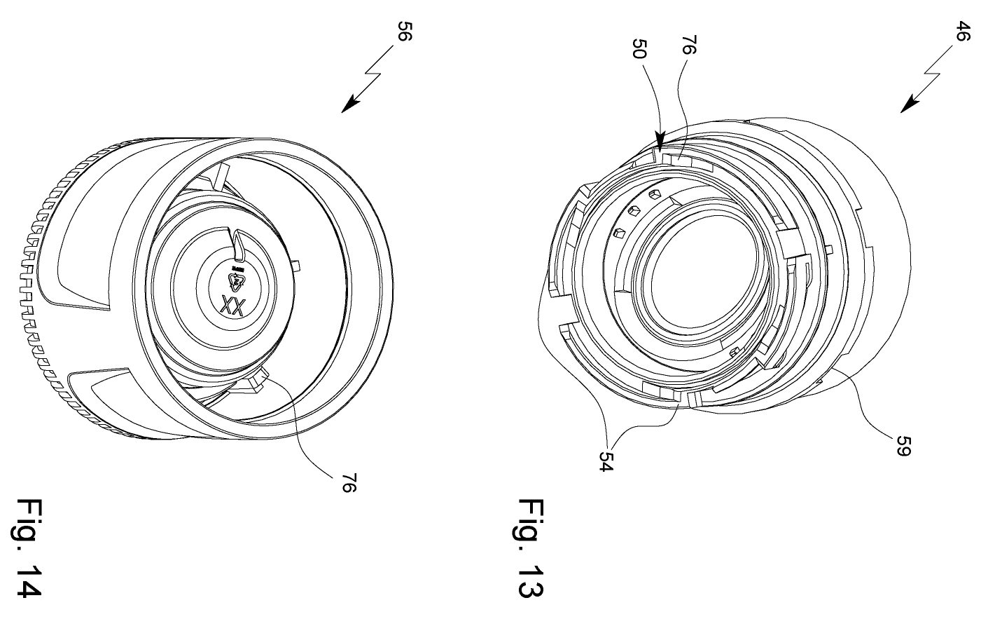

FIG. 3 shows the first connecting arrangement 2 and FIG. 4 shows the second connecting arrangement 4, while FIG. 11 is a perspective view of a third connecting arrangement 45, FIG. 12 is a perspective view of a closure cap 55 of the third connecting arrangement, FIG. 13 is a perspective view of a fourth connecting arrangement 46 and FIG. 14 is a perspective view of a closure cap 56 of the fourth connecting arrangement 46. The closure caps 55, 56 will be discussed in greater detail later. It should be noted at this point, however, that the closure caps 55, 56 shown by way of example for the third and fourth connecting arrangements 45, 46 may also be accordingly provided for the first and second connecting arrangements 2, 4.

A proposed connecting system 5 may comprise, for producing the fluidic connection F, a first connecting arrangement 2 and a second connecting arrangement 4, which can be coupled to one another and are designed to bring about an opening by coupling, as a result of which a passage P is produced, in particular as described above, and the connecting system 5 may additionally comprise, for producing a fluidic connection F, the third connecting arrangement 45 shown by way of example in FIG. 11 and the fourth connecting arrangement 46 shown by way of example in FIG. 13, which are coupled to one another and designed to bring about an opening by coupling, as a result of which a passage P is produced.

In other aspects of the present invention, the third connecting arrangement 45 preferably corresponds to the first connecting arrangement 2, or vice versa. In other aspects of the present invention, the fourth connecting arrangement 46 preferably corresponds to the second connecting arrangement 4, or vice versa.

The first and second connecting arrangement 2, 4 as well as the third and fourth connecting arrangement 45, 46 preferably have a similar construction in relation to the coupling arrangement 17 and the mouth 19 and/or in relation to the sealing arrangement 34 and the receptacle 35.

Accordingly, the first connecting arrangement 2 and the third connecting arrangement 45 are constructed substantially identically and the second connecting arrangement 4 and the fourth connecting arrangement 46 are constructed substantially identically, such that, in principle, it is possible to couple the first connecting arrangement to the fourth connecting arrangement and/or to couple the second connecting arrangement to the third connecting arrangement.

In order to prevent coupling of connecting arrangements 2, 4, 45, 46 associated with differently sized containers 1, 3 that accordingly regularly have different volumes, such that intended mixing ratios of container contents can be ensured, the connecting arrangements 2, 4, 45 and 46 preferably additionally each comprise a mechanism in the form of a bayonet catch 47, 48, 49, 50, which makes it possible to couple the first connecting arrangement 2 to the second connecting arrangement 4 and to couple the third connecting arrangement 45 to the fourth connecting arrangement 46, while it prevents the first connecting arrangement 2 from being coupled to the fourth connecting arrangement 45 and/or prevents the second connecting arrangement 4 from being coupled to the third connecting arrangement 46.

Particularly preferably, the mechanism is formed by different bayonet catches 47, 48, 49, 50. In the example shown according to FIG. 4, it can be clearly seen that the bayonet catch 48 is formed in the manner of a lock. The bayonet catch 47 of the first connecting arrangement 2 corresponds to this such that the connecting arrangements 2, 4 can be inserted into one another by translational movement of said arrangements towards one another along the coupling axis 22. In this point, the bayonet catch 50 of the fourth connecting arrangement 46 of, for example, FIG. 13 is formed differently than, for example, that depicted in FIG. 8, such that coupling is prevented. The same also applies to the bayonet catch 49 of the third connecting arrangement 45 from FIG. 11, which is formed to be incompatible with the bayonet catch 48 of the second connecting arrangement 4, for example as depicted in FIG. 4.

The bayonet catches 47, 48, 49, 50 comprise projection-like bayonet elements 51, 52, 53, 54 which particularly preferably project radially outwards for this purpose and are complementary to one another in the first connecting arrangement 2 and the second connecting arrangement 4, such that the first connecting arrangement 2 can be coupled to the second connecting arrangement 4 by sliding into one another, the bayonet elements 51, 52 passing one another in a translational movement of the first connecting arrangement 2 relative to the second connecting arrangement 4 and the first connecting arrangement 2 and the second connecting arrangement 4 being rotatable relative to one another after the bayonet elements 51, 52 have passed one another, as a result of which they bring about locking by undercutting.

The bayonet elements 51, 54 of the first connecting arrangement 2 and the third connecting arrangement 46 are incompatible with one another and/or the bayonet elements 52, 53 of the second connecting arrangement 4 and the fourth connecting arrangement 46 are incompatible with one another, the mutually incompatible bayonet elements 52, 53 and 51, 54, respectively, preventing the bayonet elements 52, 53 and 51, 54, respectively, from passing one another and/or from forming a lock.

The bayonet catches 47, 48, 49, 50 thus preferably have a double function, namely, on one hand, using a key-lock mechanism to ensure that only compatible containers 1, 3 can be coupled to one another via the connecting arrangements 2, 4, 45, 46 and, on the other hand, to ensure that the connecting arrangements 2, 4 and 45, 46, respectively, are held in one another in a form-fitting manner by means of the bayonet catches 47, 48, 49, 50.

A corresponding container system 8 preferably has at least four containers 1, 3, which are each equipped with one of the connecting arrangements 2, 4, 45, 46. In principle, it is possible and preferred for further connecting arrangements 2, 4, 45, 46 corresponding to one another in pairs to be provided, such that six or eight or more different containers 1, 3 can each be coupled to one another exclusively in pairs via the respective connecting arrangements 2, 4, 45, 46.

Alternatively or additionally, different containers 1, 3 may also be incompatible with one another due to further or other differences.

The coupling arrangement 17 preferably comprises the closure 18 in the form of a closure plate that is integrally formed with the coupling arrangement 17 and is connected to the coupling arrangement 17 by a frangible point or line of weakness, the frangible point or line of weakness being suitable for rupturing by deformation of the coupling arrangement 17 in order to form the passage P.

In principle, it is preferable for the closure plate to be inclined, specifically preferably both with respect to the coupling axis 22 and with respect to a plane perpendicular thereto, as for example shown in FIG. 1. It has been found to be advantageous for the closure plate to be inclined, since, in this case, it tilts due to the deformation of the coupling arrangement 17 when rupturing a surrounding frangible point 23 and provides a sufficiently large opening.

Surprisingly, however, it has been found that a different procedure is more advantageous, in particular for smaller container sizes or smaller connecting arrangements such as the third connecting arrangement 45, as for example shown in FIG. 11. Here, it is preferable for the closure plate 18' to extend at least substantially perpendicularly to the tube axis 27 and to comprise asymmetrically arranged reinforcing structures 57, in particular asymmetrically arranged stiffening ribs. Otherwise, the closure 18’ preferably has the same or corresponding properties as the closure 18 of the first connecting arrangement 2.

Alternatively, or additionally, both the inclination of a closure plate and the asymmetrically arranged stiffening or weakening structures of such closure plate can be realized in combination, i.e., the same closure plate might combine them. Then, such closure plate does not extend at least substantially perpendicularly to the tube axis 27 as it is inclined. With other words, stiffening or weakening structures like stiffening ribs 72 might be arranged asymmetrically like those of the third connecting arrangement 45, as for example shown in FIG. 11.

The closure 18’ formed as the closure plate preferably comprises reinforcing structures 57 which are asymmetrically distributed in a main direction of extension of the closure plate. In the example shown according to FIG. 11, reinforcing structures 57 are sometimes displaced with respect to a center point or center of gravity of the closure plate and sometimes are also only provided on one side with respect to a center point or center of gravity. The asymmetrical stability of the closure plate which results therefrom allows for secure opening under deformation of the coupling arrangement 17, in particular for smaller connecting arrangements 2, 4 or containers.

The closure 18’ formed as the closure plate of the third connecting arrangement 45 preferably comprises one or more gussets 58 at the edge. The gussets 58 are preferably arranged on radially opposite sides of the closure plate. They are preferably provided on or in the extension of the shorter half-axis 32 of a basically oval shape of the closure plate. In the region of the gusset 58, the oval basic shape of the closure plate is accordingly pierced and guided to the outside in the form of the gussets 58.

In this connection, it is preferable for the reinforcing structures 57 to be arranged at least substantially mirror-symmetrically relative to an imaginary plane through an imaginary connecting line of the gussets 58 and a perpendicular line relative to the main plane of extension of the closure plate.

The reinforcing structures 57 are preferably rib-like or formed by ribs. The reinforcing structures 57 are preferably primarily arranged on a side facing one of the gussets 58.

As already explained at the outset, the containers 1, 3 comprise a container blank 9, 10 and the first connecting arrangement 2 or second connecting arrangement 4, which can be inserted into one another by means of an insertion movement.

For this purpose, the relevant container blank 9, 10 and the relevant connecting arrangement 2, 4 preferably have form-fitting elements 59 that are formed to be complementary to one another and prevent the connecting arrangement 2, 4 and the container blank 9, 10 from rotating relative to one another by means of a form fit when said connecting arrangement is inserted into said container blank.

The form-fitting elements 59 are preferably formed by recesses and corresponding protrusions, as for example shown by way of example in FIGS. 3 and 4, and form-fitting elements 59 that are complementary thereto are provided on the container blanks 9, 10.

The form-fitting elements 59 bring about locking by means of an insertion movement of the container blank 9, 10 and a connecting arrangement 2, 4 into one another. In particular, the form-fitting elements 59 bring about teeth and/or a lock and/or a locking mechanism.

The form-fitting elements 59 are preferably arranged on an inner, circumferential side wall of the container blank 9, 10 and on an outer, circumferential side wall of the connecting arrangement 2, 4.

In one method, the present invention relates to the production of a container 1, 3 from a container blank 9, 10 and a connecting arrangement 2, 4. The container blank 9, 10 and the connecting arrangement 2, 4 have the form-fitting elements 59 that are formed to be complementary to one another and prevent the connecting arrangement 2, 4 and the container blank 9, 10 from rotating relative to one another by means of a form fit when said connecting arrangement is inserted into said container blank.

If the container blank 9, 10 and the connecting arrangement 2, 4 are inserted into one another by means of an insertion movement, by means of the form-fitting elements 59, a position of the container blank 9, 10 relative to the connecting arrangement 2, 4 is predetermined and/or a form fit is formed which prevents the container blank 9, 10 and the connecting arrangement 2, 4 from rotating relative to one another.

Alternatively or additionally, it is possible for the container blank 9, 10 and the connecting arrangement 2, 4 to be inserted into one another by means of an insertion movement, the container blank 9, 10 preferably comprising rib-like stiffening structures 60, in particular one or more ribs.

The stiffening structures 60 in turn preferably comprise open ends 61 and the connecting arrangement 2, 4 comprises coupling structures 62 that are formed to be complementary thereto, engage in one another when the connecting arrangement 2, 4 is inserted into the container blank 9, 10, and prevent any rotation relative to one another by means of a form fit. This is shown by way of example in FIGS. 1 and 2.

The coupling structures 62 are preferably formed by recesses corresponding to the open ends 61 of the stiffening structures 60. The coupling structures 62 together with the stiffening structures 60 preferably bring about locking by means of an insertion movement of the container blank 9, 10 and a connecting arrangement 2, 4 into one another.

In particular, the coupling structures 62 together with the stiffening structures 60 form teeth, an at least partially toothing and/or a lock and/or a locking mechanism.

In particular, the open ends 61 of the stiffening structures 60 engage into the coupling structures 62 at least essentially axially, like depicted for example in FIG. 1. This axial engagement between the open ends 61 of the stiffening structures 60 and the coupling structures 62 may also provide a means for positively positioning the connecting arrangement 2,4 into the container blank 9,10 along the tube axis 27.

Alternatively, or additionally, the open ends 61 of the stiffening structures 60 engage into the coupling structures 62 at least essentially radially, as depicted for example in FIG. 2.

Alternatively, or additionally, the open ends 61 of the stiffening structures 60 preferably radially engage behind the coupling structures 62 for positively locking the outer wall 63. In this case, the open ends 61 can engage the coupling structures 62 preventing the (second) connecting arrangement 4 from rotation relative to its container blank 10 or not. Anyway, it is preferred that rotation is prevented by means of form-fitting element 59 of the (second) connecting arrangement 4.

In a proposed method, the present invention relates to the production of a container 1, 3 from a container blank 9, 10 and a connecting arrangement 2, 3, it being possible for the container blank 9, 10 and the (relevant) connecting arrangement to be inserted into one another by means of an insertion movement, and the container blank 9, 10 preferably comprising rib-like stiffening structures 60, the stiffening structures 60 comprising open ends and the connecting arrangement 2, 4 comprising coupling structures 62 that are formed to be complementary or partially complementary thereto, and the container blank 9, 10 and the connecting arrangement 2, 4 being inserted into one another by means of an insertion movement, as a result of which the open ends and the coupling structures 62 engage in one another, such that the container blank 9, 10 and the connecting arrangement 2, 4 are prevented from rotating relative to one another and/or a position of the container blank 9, 10 relative to the connecting arrangement 2, 4 is predetermined during the insertion.

In FIGS. 2 and 5-7, the first and/or second connecting arrangement 2, 4 comprises an offset 77 between the closure 20 and the coupling arrangement 17 and a circumferential outer wall 63, the offset 77 being stiffened by one or more ribs 67.

The ribs are preferably arranged on a side facing the interior of the container 1 in the assembled state. The ribs preferably extend at least substantially radially relative to the tube axis 27 or coupling axis 22 and/or at least substantially along the entire offset 77. Alternatively or additionally, the first connecting arrangement 2 has an offset, which can also be stiffened by ribs (not shown).

The container blank 9, 10 preferably comprises a bottle neck 15, 16 that opens into a removal opening 11, 12 and a circumferential outer wall of the container blank 9, 10 which connects the bottle neck 15, 16 to an open tubular end 64 provided on the side facing away from the bottle neck 15, 16, for inserting the connecting arrangement 2, 4.

Preferably, the container blank 9, 10 comprises one or more stiffening structures 60 in the form of ribs for stiffening its outer wall which extend at least substantially from the bottle neck 15, 16 in the direction of the open end 61.

The one or more ribs are preferably arranged on a side of the outer wall of the container blank 9, 10 facing the interior of the container blank 9, 10. The one or more ribs may openly project into the interior of the container blank 9, 10. The one or more ribs may comprise, on an end 61 facing away from the bottle neck 15, 16, an end portion 65 spaced apart from the outer wall of the container blank 9, 10 for engaging in a coupling structure 62 formed by a recess in the connecting arrangement 2, 4.

The tubular coupling arrangement 17 preferably comprises a circumferential wall 66, in particular formed by the first portion 29, the second portion 31 and/or the step portion 30.

The circumferential wall 66 of the tubular coupling arrangement 17 preferably comprises one or more ribs 67 and/or folded structures 68 for stiffening the tubular coupling arrangement 17 in the direction of the tube axis 27 or coupling axis 22.

FIG. 15 is a cross section through the first connecting arrangement 2 perpendicularly to the coupling axis 22 in the direction of the container 1 behind the closure 18, in which the ribs 67 and/or folded structures 68 can be seen.

The ribs 67 and/or folded structures 68 are preferably elongated, with a main extension extending in the direction of the tube axis 27 or coupling axis 22. The ribs 67 and/or folded structures 68 are preferably formed integrally with the wall 66.

The preferably circumferential wall 66 of the tubular coupling arrangement 17 preferably has a radius 69 that increases starting from an open end or the cutting edge 21. The increasing radius 69 is preferably formed by an inclined step and/or a conical jacket portion. In this regard, reference is additionally made to FIGS. 8 and 11.

The step and/or the conical jacket portion may be inclined relative to the tube axis 27 or coupling axis 22 at an angle 70. The step and/or the conical jacket portion preferably encloses an angle 70 of preferably more than 15 degrees and/or less than 75 degrees together with the tube axis 27. The angle 70 is preferably obtuse relative to adjacent portions of the tubular coupling arrangement 17 or the first portion 29 thereof which has the cutting edge 21.

The radius 69, which is smaller in the region of the cutting edge 21 and increases therefrom, preferably forms an insertion aid.

It is further preferable for the step and/or the conical jacket portion to be formed on an end face of a portion provided between two weakened regions 28 of the coupling arrangement 17. This is shown by way of example in FIGS. 3 and 11.

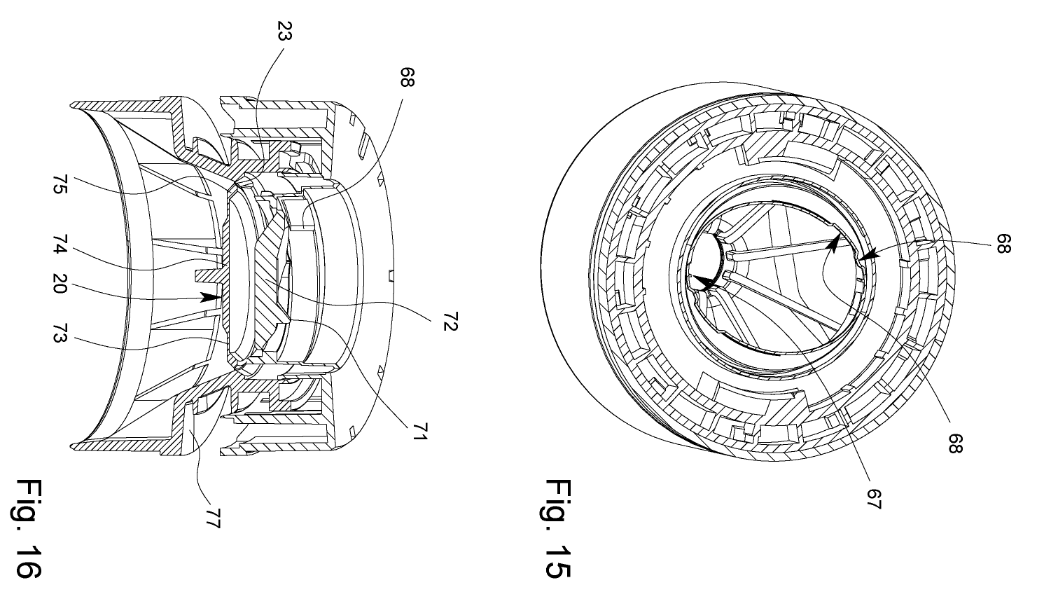

An improved closure plate which forms the closure 18 of the coupling arrangement 17 is shown in FIGS. 1 and 5-7 as well as in FIG. 16, which shows another longitudinal section through the proposed connecting system 5 in the first connecting position.

With reference to FIG. 16, the closure plate comprises a structure 71 that extends transversely to a main plane of extension and is designed to form a stop on a side of the closure plate facing the structure during opening, by means of which stop the closure plate can be supported on the coupling arrangement 17 in order to also cause an opening on a side facing away from the stop.

The structure 71 or the stop is preferably a stiffening structure or forms a part thereof, in particular a stiffening rib 72. The structure 71 is therefore preferably formed by one or more ribs. For this purpose, one of the ribs may have a protrusion, which forms the stop.

With reference to FIG. 8, the closure 20 of the second connecting arrangement 4 is preferably formed by a closure plate. This is particularly preferably delimited by a frangible point 23 in the form of a fragile line of weakness and additionally comprises an in particular structurally weakened region.

The closure 20 preferably has a centrally arranged stiffening 74 that is surrounded by the weakened region 73. The closure 20 preferably comprises a frame 75 that connects the line of weakness to the weakened region 73.

With reference to FIGS. 12 and 14, the (relevant) connecting arrangement 2, 4 preferably comprises a closure cap 55, 56. In the example shown, the closure cap 55, 56 is in each case designed to cover or close the closure 18, 20 of the connecting arrangement 2, 4, 45, 46, in particular in an airtight and/or bacteria-tight manner.

This aspect will be explained in greater detail in the following with reference to the third and fourth connecting arrangement 45, 46, but preferably applies accordingly to the first and second connecting arrangement 2, 4. Closure caps corresponding to the first and/or second connecting arrangement 2, 4 may correspond, with the same or similar function, to the first and/or second connecting arrangement 2, 4 when adapted accordingly.

As already explained above, in other aspects of the present invention as well as in the present aspect, the third connecting arrangement 45 preferably corresponds to the first connecting arrangement 2, or vice versa. In other aspects of the present invention, the fourth connecting arrangement 46 preferably corresponds to the second connecting arrangement 4, or vice versa.

The relevant closure cap 55, 56 and the relevant connecting arrangement 45, 46 comprise mutually corresponding guide surfaces 76. The guide surfaces 76 have an incline relative to one another by means of which, when the closure cap 55, 56 rotates relative to the connecting arrangement 2, 4, a force that separates the closure cap 55, 56 from the connecting arrangement 2, 4 is generated.

In an embodiment, in particular for the closure cap 56 of the second or fourth connecting arrangement 4, 46, the guide surfaces 76 are formed by a cam and a slide, the cam having an incline and the cam being guided in the slide.

Alternatively or additionally, in particular for the first or third connecting arrangement 2, 45, it is provided that the closure cap 55 comprises a wall which has an incline at an open edge, and that the connecting arrangement 2, 45 comprises a sliding surface which corresponds to the edge and against which the edge is supported when the closure cap rotates relative to the connecting arrangement with its incline, or vice versa.

The described aspects can be implemented separately and combined with one another, with it being possible to achieve different synergistic effects by means of different combinations.

For example, the first connecting arrangement 2 or the coupling arrangement 17 is particularly advantageous if it both comprises one or more weakened regions 28 and additionally comprises the folded structure 68, preferably on a side facing away from the cutting edge 21. In this case, the weakened region(s) 28 can thus be arranged in the first portion 29 of the coupling arrangement 17, while the folded structure 68 is implemented in the second portion 31 of the coupling arrangement 17. In combination, stability of the coupling arrangement 17 is maintained in the direction of the coupling axis 22, while radial deformability is further improved overall. In addition, the first portion 29 for stabilizing the cutting edge 21 may have a greater wall thickness than the second portion 31 comprising the folded structure 68. Therefore, overall, material savings, a stable cutting edge 21 and the improved radial deformability are achieved in combination.

Alternatively or additionally, in a further advantageous combination, the folded structure 68 and/or the weakened region(s) 28 are further combined with the step portion 30, in any case in portions along the circumferential line / surface of the coupling arrangement 17. In this case, the step portion 30 may be provided between the first portion 29 and the second portion 31 of the coupling arrangement 17 or between the region comprising the weakened region(s) 28 and the region comprising the folded structure 68. This combination has proven to be particularly advantageous in order to achieve particularly simple radial formability with sufficient axial stability as a result, such that, during the coupling of the first connecting arrangement 2 to the second connecting arrangement 4, the cutting edge 21 can cut open the frangible point 23 of the closure 18 to form the mouth 19, while the subsequent radial deformation of the coupling arrangement 17 can be achieved particularly easily, i.e. with relatively low torques.

Most preferably, the step portion 30 (in the direction of the coupling axis 22) is smaller behind a projecting tip of the cutting edge 21 than in other regions, or is not present. In this way, the stability of the coupling arrangement 17 can be improved in the region in which the cutting edge 21 first and/or primarily acts on the frangible point 23.

Another, particularly advantageous combination of aspects relates to the bayonet elements 51-54, which may comprise one or more guide surfaces 76 in order to cause the closure caps 55, 56 to be levered off when one of said closure caps is rotated. The bayonet elements 51-54 have a certain radial extension for the function of the bayonet catches 47-50. This radial expansion produces an end face that faces outwards or faces away from the interior 6, 7, which may be advantageously used without additional use of material to form the guide surface 76. Side surfaces of the bayonet elements 51-54 and the surface facing inwards or facing the interior 6, 7 are primarily functional for the relevant bayonet catch 47-50, such that, in a synergistic manner, the end face that faces outwards or faces away from the interior 6, 7 can advantageously produce the guide surface 76.

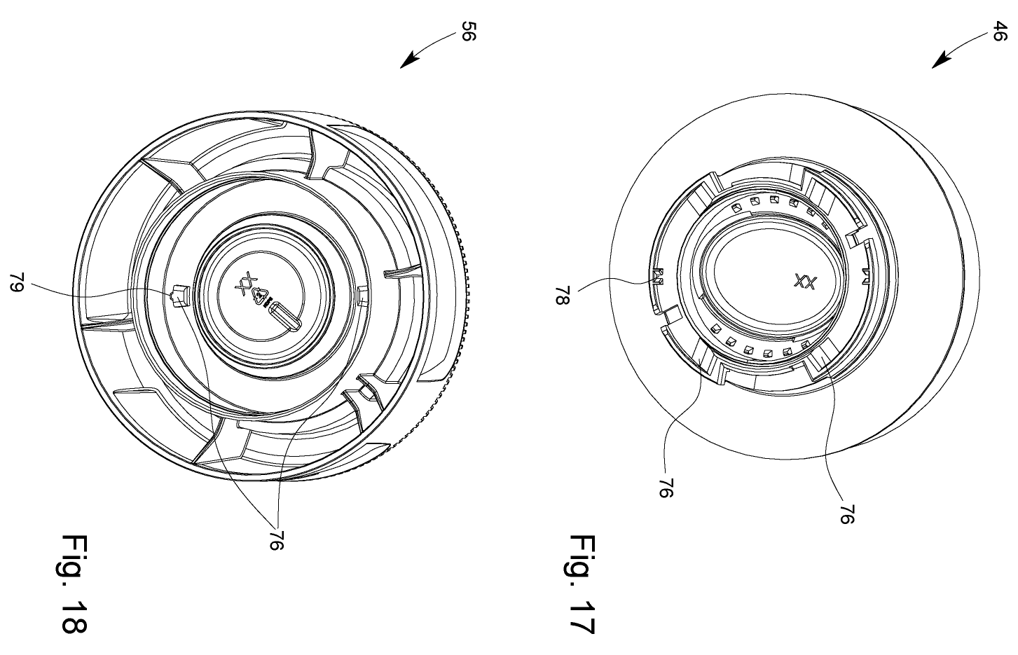

FIGS. 17-20 show an alternative embodiment of the connecting arrangement 46 according to FIG. 13 and the corresponding closure cap 56 according to FIG. 14. Thus, it is referred to the discussion of those Figures and the discussions both Figures refer to. In the following, the focus is merely on the aspects which differ from the fourth connecting arrangement 46 and its closure cap 56 according to FIG. 13 and 14. The same reference numbers are used for similar parts.

The connecting arrangement 46 according to FIG. 17 has a higher diameter compared to the connecting arrangement 46 according to FIG. 13. The closure cap 56 according to FIG. 18 has a corresponding diameter being higher than that of closure cap 56 depicted in FIG. 14 accordingly. This is achieved by constructional elements adapting functional parts to the higher diameter and/or scaling. However, the in the following discussed features can be applied to different diameters and, in particular, to the embodiment according to FIG. 13 and 14 as well.

The connecting arrangement 46 according to FIG. 17 comprises a first blocking element 78. This blocking element 78 can be configured to form a reversible/non-permanent lock, preferably snap-lock, with a second blocking element 79 of the closure cap 56 depicted in FIG. 18.

The lock provided by the combination of preferably engaging blocking elements 78, 79 preferably is reversible, i.e., can be released upon applying sufficient torque to the closure cap 56 relative to the connecting arrangement 46.

In the example shown, the first blocking element 78 is or comprises an opening, preferably opening in a radially inward direction, while the second blocking element 79 is or comprises a complementary structure for engaging the first blocking element 78 when the closure cap 56 is mounted on the connecting arrangement 46 (completely/until stop).

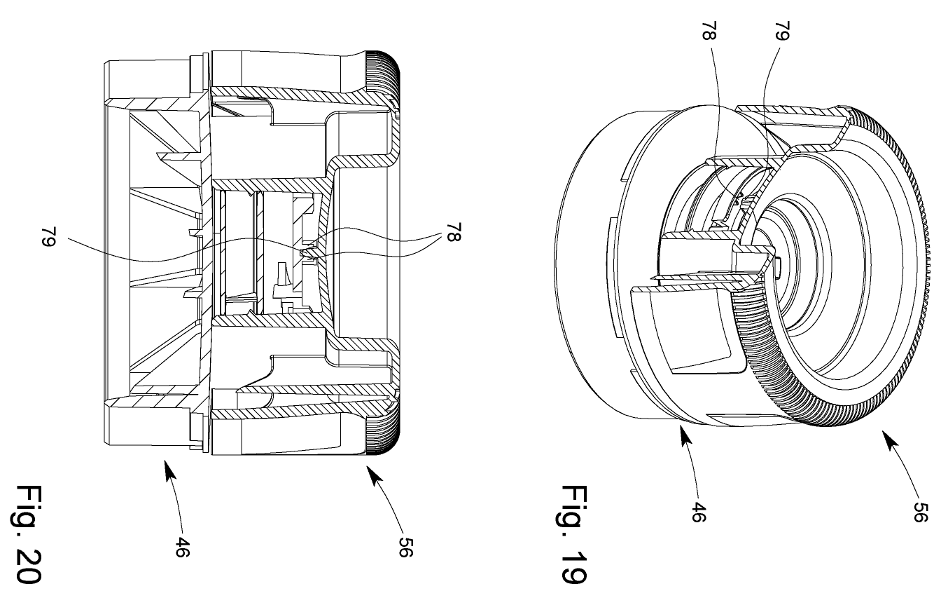

In FIG. 19, the connecting arrangement 46 and its corresponding closure cap 56 are shown in a position where the closure cap 56 is moved away from the connecting arrangement 46 such that based on the depicted partial cut of the closure cap 56 both blocking elements 78, 79 are visible, here are in a disengaged position. In FIG. 20, which shows a cross-section of the combination of the connecting arrangement 46 and its closure cap 56 along a cutting plane which is moved slightly radially inwardly based on the cutting plane used for the partial cut depicted in FIG. 19, the closure cap 56 is not anymore moved away from the connecting arrangement 46 but is snap-locked to or held otherwise at the connecting arrangement 46 (up to stop). Accordingly, the blocking elements 78, 79 engage as can be seen in FIG. 20.

For starting a rotational movement of the closure cap 56 relative to the connecting arrangement 46, a torque needs to the applied to the closure cap 56 relative to the connecting arrangement 46 or vice versa such that deformation of the first and/or second blocking elements 78, 79 causes disengagement of the blocking elements 78, 79. This disengagement enables essentially free rotational movability towards the structure, in particular inclined sections of guide surfaces 76, that enables or supports separation of the closure cap 56 from the connecting arrangement 46 or vice versa. In this regard, reference is made to the discussion in context of FIGS. 13 and 14 as well as discussions those passages referring to.

It is preferred that one or both blocking elements 78, 79 form part of or are attached or arranged at a structure or structures forming the guide surfaces 78. In particular, in the embodiment shown in FIG. 17, the first blocking element 78 of the connecting arrangement 46 is or comprises a recess formed by walls attached to or formed with an inner surface of the connecting arrangement/extend in a radially inward direction such that the recess is accessible in a radially outwardly direction. The first blocking element 78 and/or the second blocking element 79 can have weak structures that enable deformation in order to facilitate disengagement of the blocking elements 78, 79 upon sufficient torque.

The second blocking element 79 of the closure cap 56 in the embodiment shown comprises a protrusion like a bead or cam for extending into the first blocking element 78, thus causing engagement of the blocking elements 78, 79. In the embodiment shown in FIGS. 18-20, the protrusion extends essentially in a radially outward direction.

However, the structure of the blocking elements 78, 79 can be exchanged and the same or at least a similar effect can be obtained. Further, different realizations may be applied in order to arrive at the function of the first and second blocking elements 78, 79.

The connecting arrangement 46 and the closure cap 56 preferably each comprise at least one, in the embodiment shown two blocking elements 78, 79. Those blocking elements in the embodiment shown are arranged on opposite sides relative to the coupling axis 22/ tube axis 27. At least or more than two blocking elements 78, 79 on each the connecting arrangement 46 and the closure cap 56 can be provided accordingly on respectively corresponding positions such that corresponding blocking elements 78, 79 preferably engage and disengage simultaneously.

In a corresponding or complementary manner, other combinations or sub-combinations of the different aspects of the present invention may be advantageous.

### LIST OF REFERENCE SIGNS

1 first container
2 first connecting arrangement
3 second container
4 second connecting arrangement
5 connecting system
6 interior of the first container
7 interior of the second container
8 container system
9 container blank
10 container blank
11 removal opening of the first container
12 removal opening of the second container
13 removal opening closure of the first container
14 removal opening closure of the second container
15 bottle neck of the first container
16 bottle neck of the second container
17 coupling arrangement
18 closure
19 mouth
20 closure
21 cutting edge
22 coupling axis
23 frangible point
24 directional arrow
25 directional arrow
26 open end
27 tube axis
28 weakened region
29 portion of the coupling arrangement
30 step portion
31 portion of the coupling arrangement
32 first half-axis
33 second half-axis
34 sealing arrangement
35 receptacle
36 inwardly facing circumferential sealing surface
37 wall
38 outwardly facing circumferential sealing surface
39 pressing element
40 contact surface
41 foot point
42 undercut
43 bead
44 clear width
45 third connecting arrangement
46 fourth connecting arrangement
47 bayonet catch
48 bayonet catch
49 bayonet catch
50 bayonet catch
51 bayonet element
52 bayonet element
53 bayonet element
54 bayonet element
55 closure cap
56 closure cap
57 reinforcing structures
58 gusset
59 form-fitting element
60 stiffening structure
61 end of the stiffening structure
62 coupling structure
63 outer wall
64 tubular end
65 end portion
66 wall
67 rib
68 folded structure
69 radius
70 angle (oval contact)
71 structure
72 stiffening rib
73 weakened region
74 stiffening
75 frame
76 guide surface
77 offset
78 first blocking element
79 second blocking element
F fluidic connection
P passage
φ angle

What is claimed is:

1. A connecting system for producing a fluidic connection between a first contain-er and a second container, wherein the connecting system for producing a fluidic connection comprises a first connecting arrangement and a second connecting arrangement, which are couplable to one another and are configured to bring about an opening by coupling, as a result of which a passage is produced which is suitable for interconnecting the interiors of the containers,
one of the first and second connecting arrangements comprising a tubular sealing arrangement and another of the first and second connecting arrangements comprising a structure that is complementary to the tubular sealing arrangement, so that the tubular sealing arrangement comes into sealing contact with the complementary structure by means of a translational relative movement of the connecting arrangements along a coupling axis,
the sealing arrangement comprising an outwardly facing circumferential sealing surface for sealing contact with an inwardly facing circumferential sealing surface of the complementary structure,
wherein
the other of the first and second connecting arrangements comprises one or more pressing elements that are offset inwards with respect to the coupling axis relative to the circumferential sealing surface of the complementary structure in order to press the circumferential sealing surface of the tubular sealing arrangement against the circumferential sealing surface of the complementary structure.

2. The connecting system of claim 1, wherein the tubular sealing arrangement has different wall thicknesses at an open edge along a circumferential line or surface.

3. The connecting system of claim 1, wherein the connecting arrangement comprises a tubular coupling arrangement having a tube axis, the coupling arrangement be-ing closed in an original state and being openable to form the passage by deforming the coupling arrangement transversely to its tube axis, the coupling arrangement being non-circular in cross section, as a result of which it has at least one first half-axis having a minimum length and at least one second half-axis having a maximum length, and the tubular sealing arrangement having a lower wall thickness in alignment with the first half-axis than in alignment with the second half-axis.

4. The connecting system of claim 1, wherein the pressing elements is/are pins extending at least substantially in parallel with the coupling axis.

5. Connecting system of claim 4, wherein the pin or pins have a radially outwardly directed contact surface.

6. The connecting system of claim 5, wherein the contact surface is spaced apart from a foot point of the pin or the respective pins.

7. The connecting system of claim 5, wherein the contact surface protrudes radially outwards, such that an undercut results between the contact surface and the foot point of the pin in the direction of the coupling axis.

8. The connecting system of claim 1, wherein the one of the first and second connecting arrangements comprises a bead along the circumferential surface of the tubular sealing arrangement, which bead has an oversize relative to the circumferential sealing surface of the structure.

9. The connecting system of claim 8, wherein the bead forms an uninterrupted sealing surface on a radially outwardly facing circumferential line.

10. The connecting system of claim 8, wherein the bead has an oversize relative to a clear width between the outwardly facing circumferential surface and one or more pressing elements.

11. The connecting system of claim 10, wherein the pressing elements exert a radial pressure on the sealing arrangement in the coupled state of the connecting arrangements, by means of which the bead is brought into tight contact with the inwardly facing circumferential sealing surface of the structure.

12. Connecting A connecting system for producing a fluidic connection between a first container and a second container, wherein the connecting system for producing a fluidic connection comprises a first connecting arrangement and a second connecting arrangement, which can be coupled to one another and are designed to bring about an opening by coupling, as a result of which a passage is produced which is suitable for interconnecting the interiors of the containers,
the first connecting arrangement comprising a tubular sealing arrangement and the second connecting arrangement comprising a structure that is complementary to the tubular sealing arrangement,
the sealing arrangement comprising an outwardly facing circumferential sealing surface for sealing contact with the circumferential sealing surface of the receptacle,
wherein
the first connecting arrangement comprises a bead along the circumferential surface of the tubular sealing arrangement, which bead has an oversize relative to the circumferential sealing surface of the structure.

13. The connecting system of claim 12, wherein the bead forms an uninterrupted sealing surface on a radially outwardly facing circumferential line.

14. The connecting system of claim 12, wherein the bead has an oversize relative to a clear width between the outwardly facing circumferential surface and one or more pressing elements.

15. The connecting system of claim 14, wherein the pressing elements exert a radial pressure on the sealing arrangement in the coupled state of the connecting arrangements, by means of which the sealing arrangement is brought into tight contact with the inwardly facing circumferential sealing surface of the structure.

16. The connecting system of claim 15, wherein the second connecting arrangement comprises one or more pressing elements that are offset inwards with respect to the coupling axis relative to the circumferential sealing surface of the complementary structure in order to press the bead of the circumferential sealing surface of the tubular sealing arrangement against the circumferential sealing surface of the complementary structure.

17. The connecting system of claim 12, wherein the tubular sealing arrangement has different wall thicknesses at an open edge along a circumferential line or surface.

18. The connecting system of claim 12, wherein the connecting arrangement comprises a tubular coupling arrangement having a tube axis, the coupling arrangement being closed in an original state and being openable to form the passage by deforming the coupling arrangement transversely to its tube axis, the coupling arrangement being non-circular in cross section, as a result of which it has at least one first half-axis having a minimum length and at least one second half-axis having a maximum length, and the tubular sealing arrangement having a lower wall thickness in alignment with the first half-axis than in alignment with the second half-axis.

19. The connecting system of claim 12, wherein the pressing elements is/are pins extending at least substantially in parallel with the coupling axis having have a radially outwardly directed contact surface.
